(19) United States
(12) Patent Application Publication
(10) Pub. No.: US 2019/0143964 A1
(43) Pub. Date: May 16, 2019

(54) Systems and methods for performing an injury-mitigating autonomous maneuver in face of an imminent collision

(71) Applicants: Gal Zuckerman, Holon (IL); Moshe Salhov, Herzeliya (IL)

(72) Inventors: Gal Zuckerman, Holon (IL); Moshe Salhov, Herzeliya (IL)

(21) Appl. No.: 16/190,369

(22) Filed: Nov. 14, 2018

Related U.S. Application Data
(60) Provisional application No. 62/586,927, filed on Nov. 16, 2017.

(51) Int. Cl. B60W 30/085; G05D 1/00; G05D 1/02; B60W 30/095; B60W 30/09; B60R 21/00

(52) U.S. Cl. CPC B60W 30/085; G05D 1/0088; G05D 1/0214; B60W 30/0956; B60W 30/09; B60R 21/00; B60R 2021/0002; B60W 2720/14; B60W 2550/10; B60W 2550/20; G05D 2201/0213; B60R 2021/0032; B60W 2400/00

(57) ABSTRACT

On-road autonomous vehicles and other on-road vehicles operative to perform various autonomous maneuvers to reduce, avoid, or alleviate injuries in conjunction with an anticipated collision of the vehicle with a foreign object. A foreign object approaching is detected by the vehicle, object dynamics are calculated, and a prediction is made that a collision is either unavoidable or preferred over a different outcome. As a result, the vehicle then decides to perform an injury-mitigating autonomous maneuver in the short period of time between such a detection/prediction and the actual collision, in which such a maneuver is not expected to circumvent the collision, but is rather designed to mitigate injuries caused by the collision. The injury-mitigating autonomous maneuver may include autonomously and controllably changing orientation or trajectory of the vehicle relative to the foreign object or relative to the expected point of impact.

### CROSS REFERENCE TO RELATED APPLICATIONS

This Application claims priority to U.S. Provisional Patent Application No. 62/586,927, filed on Nov. 16, 2017, which is hereby incorporated by reference.

### BACKGROUND

Car accidents involving human casualties are on the rise, with traffic densities growing and human attention easily distracted. Sophisticated accident mitigating technologies exist and are taking center stage, but with the general result of perhaps avoiding some of the accidents, and possibly reducing collision induced forces, but still not eliminating human casualties when accidents are unavoidable.

### SUMMARY

On embodiment is a method for reducing or avoiding injuries in conjunction with an imminent collision of an autonomous on-road vehicle with a foreign object, comprising: detecting, using sensors onboard an autonomous on-road vehicle currently moving, a foreign object approaching the autonomous on-road vehicle; predicting, by the autonomous on-road vehicle, based on said detection and related data processing, that said foreign object is about to collide with the autonomous on-road vehicle; identifying positions of all passengers in the autonomous on-road vehicle; and adapting autonomously a current trajectory or orientation of the autonomous on-road vehicle, based on said prediction and identification, so as to cause the autonomous on-road vehicle to collide with the foreign object in a particular spot or orientation of the autonomous on-road vehicle that is likely to reduced or avoid injury to the passengers.

On embodiment is a system operative to reduce or avoid injuries in conjunction with an imminent collision of an autonomous on-road vehicle with a foreign object. The system is configured to: detect, using sensors onboard an autonomous on-road vehicle currently moving, a foreign object approaching the autonomous on-road vehicle; predict, based on said detection and related data processing, that said foreign object is about to collide with the autonomous on-road vehicle; identify positions of all passengers in the autonomous on-road vehicle; and adapt autonomously a current trajectory or orientation of the autonomous on-road vehicle, based on said prediction and identification, so as to cause the autonomous on-road vehicle to collide with the foreign object in a particular spot or orientation of the autonomous on-road vehicle that is likely to reduced or avoid injury to the passengers.

One embodiment is a method for reducing or avoiding injuries in conjunction with an imminent collision of an autonomous on-road vehicle with a foreign object, comprising: detecting, using sensors onboard an autonomous on-road vehicle currently moving, a foreign object approaching the autonomous on-road vehicle; predicting, by the autonomous on-road vehicle, based on said detection and related data processing, that said foreign object is about to collide with the autonomous on-road vehicle; and adapting autonomously a current trajectory or orientation of the autonomous on-road vehicle, based on said prediction and detection, so as to cause the autonomous on-road vehicle to collide with the foreign object in a particular spot of the autonomous on-road vehicle that is specifically designed to contain or at least reduce an impact of said collision.

One embodiment is a system operative to reduce or avoid injuries in conjunction with an imminent collision of an autonomous on-road vehicle with a foreign object. The system is configured to: detect, using sensors onboard an autonomous on-road vehicle currently moving, a foreign object approaching the autonomous on-road vehicle; predict, based on said detection and related data processing, that said foreign object is about to collide with the autonomous on-road vehicle; and adapt autonomously a current trajectory or orientation of the autonomous on-road vehicle, based on said prediction and detection, so as to cause the autonomous on-road vehicle to collide with the foreign object in a particular spot of the autonomous on-road vehicle that is specifically designed to contain or at least reduce an impact of said collision.

One embodiment is a method for reducing or avoiding injuries in conjunction with an imminent collision of an autonomous on-road vehicle with a pedestrian, comprising: detecting, using sensors onboard an autonomous on-road vehicle currently moving, that the autonomous on-road vehicle is approaching a pedestrian; predicting, by the autonomous on-road vehicle, based on said detection and related data processing, that said approach is being made too fast to avoid hitting the pedestrian; and adapting autonomously a current trajectory or orientation of the autonomous on-road vehicle, based on said prediction and detection, so as to cause the autonomous on-road vehicle to collide with the pedestrian in a particular soft spot of the autonomous on-road vehicle that is specifically designed to contain or at least reduce an impact of said collision on the pedestrian. In one embodiment, the particular soft spot comprises at least one of: (i) a cushion or another soft element, (ii) an inflatable cushion, which inflates upon said detection and prediction, (iii) a static cushion, (iv) a spring-like mechanism operative to be deployed from a contracted position into an extracted position prior to the collision and as a result of said prediction, and (v) a certain front section or element of the car operative to collapse during said collision.

One embodiment is a system operative to reduce or avoid injuries in conjunction with an imminent collision of an autonomous on-road vehicle with a pedestrian. The system is configured to: detect, using sensors onboard an autonomous on-road vehicle currently moving, that the autonomous on-road vehicle is approaching a pedestrian; predict, based on said detection and related data processing, that said approach is being made too fast to avoid hitting the pedestrian; and adapt autonomously a current trajectory or orientation of the autonomous on-road vehicle, based on said prediction and detection, so as to cause the autonomous on-road vehicle to collide with the pedestrian in a particular soft spot of the autonomous on-road vehicle that is specifically designed to contain or at least reduce an impact of said collision on the pedestrian. In one embodiment, the particular soft spot comprises at least one of: (i) a cushion or another soft element, (ii) an inflatable cushion, which inflates upon said detection and prediction, (iii) a static cushion, (iv) a spring-like mechanism operative to be deployed from a contracted position into an extracted position prior to the collision and as a result of said prediction, and (v) a certain front section or element of the car operative to collapse during said collision.

### BRIEF DESCRIPTION OF THE DRAWINGS

The embodiments are herein described by way of example only, with reference to the accompanying drawings. No attempt is made to show structural details of the embodiments in more detail than is necessary for a fundamental understanding of the embodiments. In the drawings:

FIG. 1A illustrates one embodiment of an autonomous on-road vehicle detecting a foreign object approaching;

FIG. 1B illustrates one embodiment of the autonomous on-road vehicle adapting at least a current orientation thereof in anticipation of an unavoidable collision with the foreign object;

FIG. 1C illustrates one embodiment of the autonomous on-road vehicle colliding with the foreign object in a particular way facilitated by the adapted orientation;

FIG. 1D illustrates one embodiment of the autonomous on-road vehicle adapting differently the current orientation in anticipation of the unavoidable collision with the foreign object;

FIG. 1E illustrates one embodiment of the autonomous on-road vehicle colliding with the foreign object in a different way facilitated by the orientation adapted differently;

FIG. 1F illustrates one embodiment of the autonomous on-road vehicle adapting a current trajectory thereof in anticipation of the unavoidable collision with the foreign object;

FIG. 1G illustrates one embodiment of the autonomous on-road vehicle colliding with the foreign object in a certain way facilitated by the adapted trajectory;

FIG. 1H illustrates one embodiment of a method for reducing or avoiding injuries in conjunction with an imminent collision of an autonomous on-road vehicle with a foreign object;

FIG. 2A illustrates one embodiment of an autonomous on-road vehicle detecting a foreign object approaching;

FIG. 2B illustrates one embodiment of the autonomous on-road vehicle adapting a current orientation thereof and deploying a spring-like mechanism in anticipation of an unavoidable collision with the foreign object;

FIG. 2C illustrates one embodiment of the autonomous on-road vehicle colliding with the foreign object via the spring-like mechanism;

FIG. 2D illustrates one embodiment of the autonomous on-road vehicle adapting the current orientation thereof and heading toward the foreign object in anticipation of an unavoidable collision with the foreign object;

FIG. 2E illustrates one embodiment of the autonomous on-road vehicle colliding with the foreign object head-on via a front section of the autonomous on-road vehicle;

FIG. 2F illustrates one embodiment of a method for reducing or avoiding injuries in conjunction with an imminent collision of an autonomous on-road vehicle with a foreign object;

FIG. 3A illustrates one embodiment of an autonomous on-road vehicle detecting that the autonomous on-road vehicle is approaching a pedestrian;

FIG. 3B illustrates one embodiment of the autonomous on-road vehicle adapting a current orientation thereof and so as to position a soft spot toward the pedestrian;

FIG. 3C illustrates one embodiment of the autonomous on-road vehicle colliding with the pedestrian via the soft spot;

FIG. 3D illustrates one embodiment of a method for reducing or avoiding injuries in conjunction with an imminent collision of an autonomous on-road vehicle with a pedestrian;

FIG. 4A illustrates one embodiment of a vehicle detecting that the vehicle is approaching a pedestrian;

FIG. 4B illustrates one embodiment of the vehicle deploying a spring-like mechanism in anticipation of an unavoidable collision with the pedestrian;

FIG. 4C illustrates one embodiment of the vehicle colliding with the pedestrian via the spring-like mechanism and consequently reducing collision induced forces on the pedestrian;

FIG. 4D illustrates one embodiment of a method for reducing or avoiding injuries in conjunction with an imminent collision of a vehicle with a pedestrian;

FIG. 5A illustrates one embodiment of a vehicle detecting a foreign object approaching and predicting a collision;

FIG. 5B illustrates one embodiment of an airbag mechanism inside the vehicle prior to the collision between the vehicle and the foreign object, in which the airbag mechanism is still dormant;

FIG. 5C illustrates one embodiment of the airbag mechanism inside the vehicle, in which an airbag is inflated as a result of predicting the collision but still prior to the actual collision;

FIG. 5D illustrates one embodiment of the airbag mechanism in a fail-safe mode, in which the airbag is inflated as a result of actual collision forces, and in a scenario where the collision was not predicted by the vehicle;

FIG. 5E illustrates one embodiment of the vehicle with the airbag already inflated prior to the actual collision with the foreign object;

FIG. 5F illustrates one embodiment of the vehicle colliding with the foreign object but with the airbag already inflated;

FIG. 5G illustrates one embodiment of a method for safely inflating an airbag in anticipation of a collision;

FIG. 5H illustrates one embodiment of a method for safely inflating an airbag in anticipation of a collision;

FIG. 6A illustrates one embodiment of a vehicle detecting a foreign object approaching and predicting a collision;

FIG. 6B illustrates one embodiment of an airbag mechanism inside the vehicle prior to the collision between the vehicle and the foreign object, in which the airbag mechanism is still dormant;

FIG. 6C illustrates one embodiment of the airbag mechanism inside the vehicle, in which an airbag is inflated as a result of predicting the collision but still prior to the actual collision;

FIG. 6D illustrates one embodiment of the airbag mechanism in a fail-safe mode, in which the airbag is inflated as a result of actual collision forces, and in a scenario where the collision was not predicted by the vehicle;

FIG. 6E illustrates one embodiment of the vehicle with the airbag already inflated prior to the actual collision with the foreign object;

FIG. 6F illustrates one embodiment of the vehicle colliding with the foreign object but with the airbag already inflated;

FIG. 6G illustrates one embodiment of a method for inflating an airbag in anticipation of a collision;

FIG. 7A illustrates one embodiment of a vehicle with a passenger seated in a certain way;

FIG. 7B illustrates one embodiment of the vehicle automatically changing the way the passenger is seated as a result of an inevitable accident predicted by the vehicle;

FIG. 7C illustrates one embodiment of the vehicle automatically deploying an anchor in the ground as a result of an inevitable accident predicted by the vehicle;

FIG. 7D illustrates one embodiment of a method for activating a safety mechanism in anticipation of an imminent car accident;

FIG. 8A illustrates one embodiment of an autonomous on-road vehicle detecting a at least two immediate objects;

FIG. 8B illustrates one embodiment of the autonomous on-road vehicle selecting a crash target out of the at least two immediate objects;

FIG. 8C illustrates one embodiment of the autonomous on-road vehicle colliding intentionally with the crash target selected;

FIG. 8D illustrates one embodiment of a method for selecting a crash target in conjunction with an imminent car accident;

FIG. 9A illustrates one embodiment of an autonomous on-road vehicle detecting a at least two immediate objects including one soft target;

FIG. 9B illustrates one embodiment of the autonomous on-road vehicle selecting the soft target as a crash target; and

FIG. 9C illustrates one embodiment of the autonomous on-road vehicle colliding intentionally with the soft target.

### DETAILED DESCRIPTION

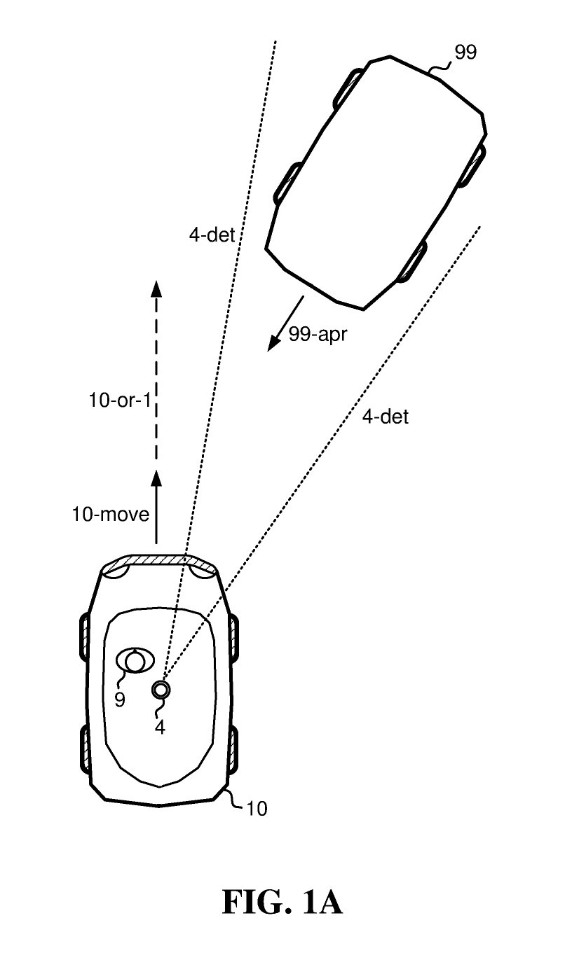

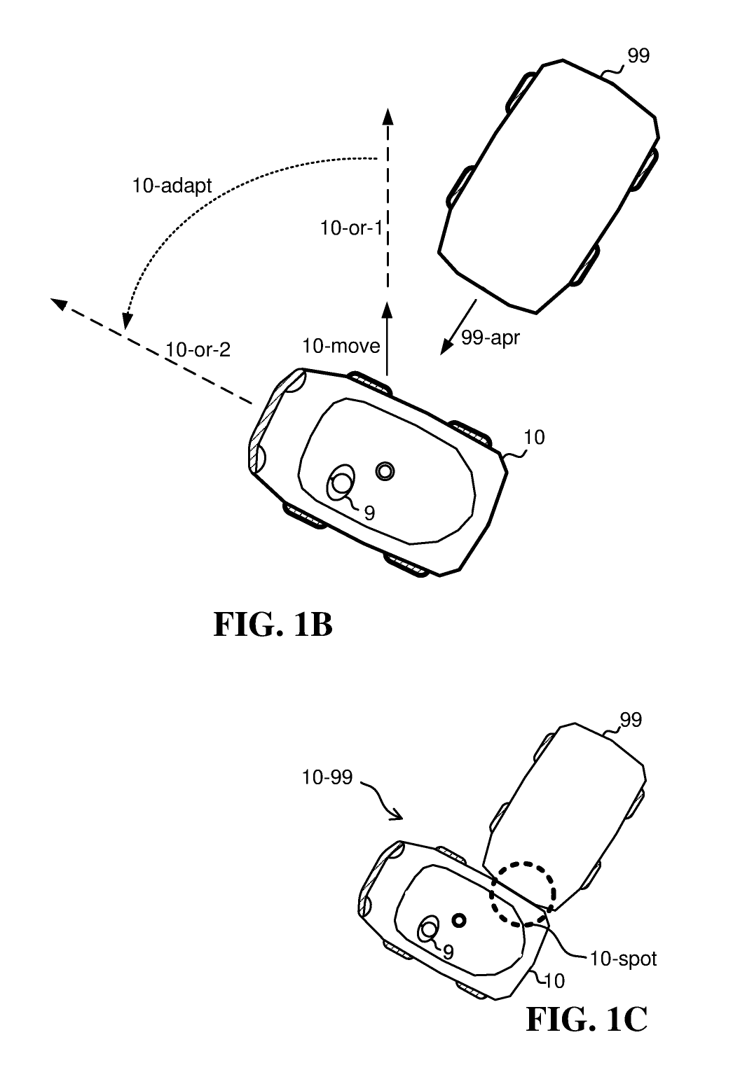

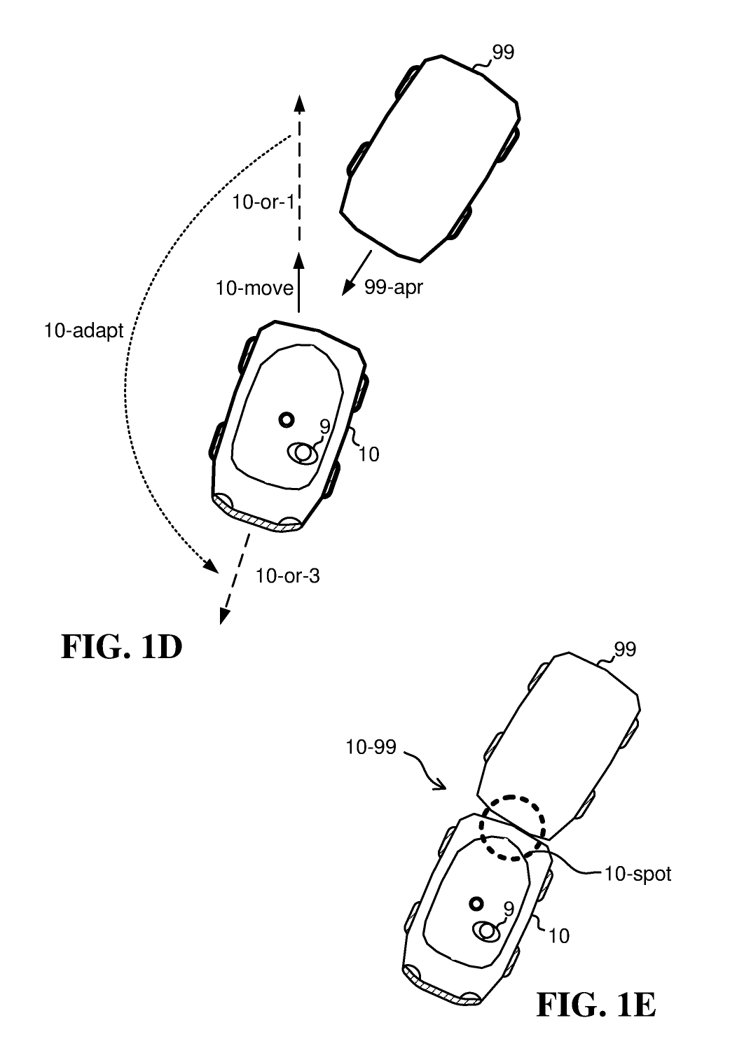

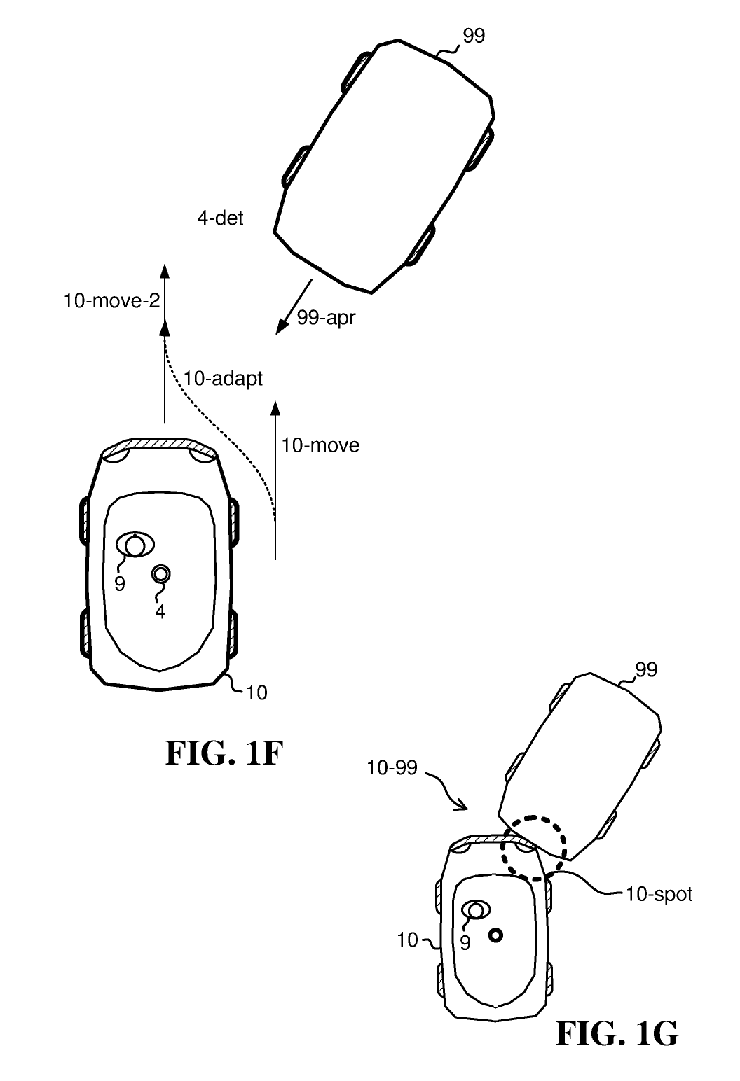

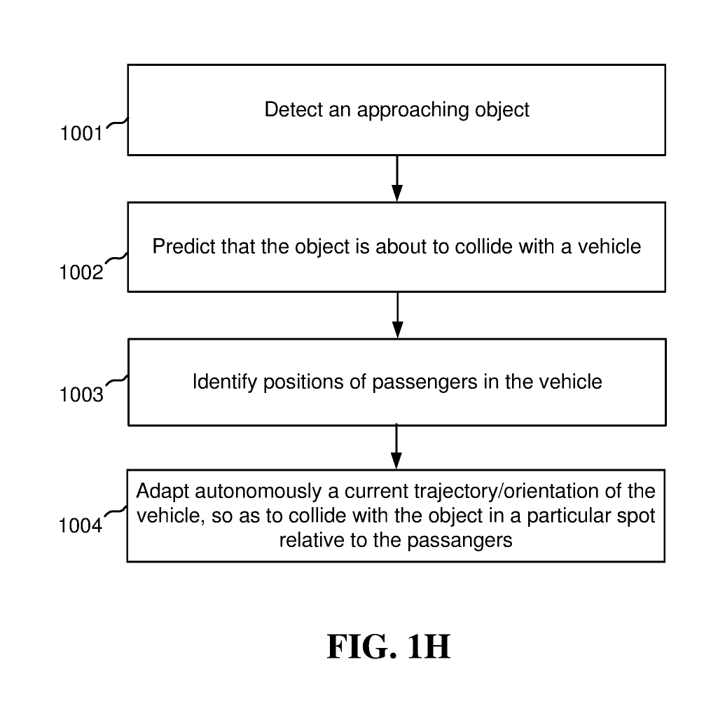

FIG. 1A illustrates one embodiment of an autonomous on-road vehicle 10 detecting 4-det a foreign object 99 approaching 99-apr. The autonomous on-road vehicle 10 is shown with a passenger 9 onboard, which is depicted as seating in a front-left seat of the autonomous on-road vehicle, but the passenger could also be seated in any other seat in the autonomous on-road vehicle. A single passenger 9 is depicted, but more passengers could be seated in the autonomous on-road vehicle 10. A sensor or detector 4 is shown, in which the sensor facilitates the detection 4-det of the foreign object 99. The sensor 4 could be a digital camera, an infra-red camera, a radar device, a lidar (light detection and ranging) device, or any combination thereof, or any other sensor or detector capable of facilitating detection or sensing 4-det of the foreign object 99 from a distance. It is understood that detecting the foreign object 99 is facilitated by the sensor 4, but would normally also include certain processing functions, such as image processing or signal processing functions, to accomplish a successful detection of the foreign object 99, in which the processing functions could be performed in and by the autonomous on-road vehicle 10, or the processing functions could be performed by an entity other than the autonomous on-road vehicle 10. The sensor is depicted as a single sensor, but it could be a combination of several sensors. The sensor is depicted as being located on top of the autonomous on-road vehicle 10, but it could be located in any place inside or outside the autonomous on-road vehicle, provided that it has clearance to detect the foreign object 99. The sensor is depicted as being associated with the autonomous on-road vehicle 10, but it could be unassociated with the autonomous on-road vehicle, and possibly even located in a different place such as a junction, or even on a different vehicle, provided that it has clearance to detect the foreign object 99. The sensor 4 could be any one or more of several sensors used by the autonomous on-road vehicle 10 to drive autonomously, or the sensor 4 could be independent of any other sensors used by the autonomous on-road vehicle to drive autonomously.

The autonomous on-road vehicle 10 is shown to be moving in a certain direction 10-move associated with a velocity of the autonomous on-road vehicle, and is also shown to be oriented 10-or-1 in a certain angular direction, which is a direction in which the autonomous on-road vehicle is facing. Normally, the autonomous on-road vehicle 10 direction of movement 10-move is aligned with orientation 10-or-1 (i.e., the car is facing in the direction of movement), which is depicted by the alignment of vectors 10-move and 10-or-1, but the autonomous on-road vehicle 10 could also move is a direction that is not aligned with orientation, as could be the case when the autonomous on-road vehicle slides, spins, or turns. The foreign object 99 is shown to be approaching 99-apr from a front-right side, but it could approach the autonomous on-road vehicle 10 form other directions. The foreign object 99 may be moving toward the autonomous on-road vehicle, and in which case the vector 99-apr represents a velocity of the foreign object 99, but the foreign object could also be stationary or even moving away from the autonomous on-road vehicle 10, and in that case the vector 99-apr represents a relative velocity between the foreign object 99 and the autonomous on-road vehicle 10. In general, vector 99-apr represents the general notion that the autonomous on-road vehicle 10 and the foreign object 99 are closing distance. The foreign object 99 is depicted as a vehicle of some sort, but it could also be any other object, such as a stationary street pole, toward which the autonomous on-road vehicle 10 is closing distance.

The autonomous on-road vehicle 10 detects 4-det the foreign object 99 approaching 99-apr, and may conclude that the autonomous on-road vehicle 10 is going to necessarily hit the foreign object 99, and that a collision is therefore inevitable. It is understood that it would be preferred to avoid hitting the foreign object 99 altogether, but there are situations in which avoiding a collision is not possible, perhaps because of unexpected on-road conditions, or unexpected driver behavior, a technical malfunction in one of the vehicles, or a developing object dynamics that leaves a short time for reaction. In some scenarios, colliding with the foreign object 99 is avoidable, but at the cost of colliding with yet another object, in which case the autonomous on-road vehicle 10 may decide to intentionally chose to collide with the foreign object 99 detected 4-det. The autonomous on-road vehicle 10 may utilize data gathered from sensor 4 regarding foreign object 99 approaching 99-apr, and to analyze or process such data, along with other data regarding various speeds and positions of relevant objects, to reach the conclusion that a collision is unavoidable. Such analysis and data processing could be facilitated by algorithms such as object dynamics, statistical analysis, and machine learning prediction models. After reaching the conclusion that a collision is inevitable, the autonomous on-road vehicle 10 switches to a collision mode, in which the autonomous on-road vehicle will attempt to autonomously maneuver itself into a particular collision position/orientation relative to the foreign object 99 approaching 99-apr, and such as to minimize or eliminate the risk of injuries.

FIG. 1B illustrates one embodiment of the autonomous on-road vehicle 10 adapting 10-adapt at least a current orientation 10-or-1 thereof in anticipation of an unavoidable collision with the foreign object 99. After concluding that a collision with foreign object 99 is inevitable, the autonomous on-road vehicle 10 may select a collision strategy. For example, the autonomous on-road vehicle could sense, perhaps using pressure sensors inside the seats or otherwise, that only a single passenger 9 is seating at the driver seat, and that no other passengers are in the car. In such a case, the autonomous on-road vehicle 10 may decide to change orientation from 10-or-1 to 10-or-2, and thereby effectively placing the passenger 9 away from a projected point of impact. As shown, the autonomous on-road vehicle 10 brings itself to a new orientation 10-or-2, prior to the expected collision, in which a rear-right side of the autonomous on-road vehicle, which is clear of passengers, is now facing the expected point of impact. It is noted that the passenger 9 is shown to be seated in the driver's seat, the foreign object 99 is shown to be approaching the autonomous on-road vehicle 10 from the right, and as a reaction the autonomous on-road vehicle 10 is shown to be rotating to the left, but the situation shown is just an example, and as another relevant example, which is not shown, the passenger 9 could be seated next to the driver seat or in a rear-right seat, the foreign object 99 could be approaching the autonomous on-road vehicle 10 from the left, and as a reaction the autonomous on-road vehicle 10 would be rotating to the right, thereby effectively placing the passenger 9 away from a different projected point of impact. Throughout the specifications, particular approaching directions, specific turning orientations, and certain passenger and pedestrian locations are shown, but it is understood that other directions, orientations, and positions are also possible.

Changing from orientation 10-or-1 to orientation 10-or-2 can be done in several ways, including: turning the car to the left, spinning the car to the left, sliding the car to the left, or a combination thereof, in which sliding or spinning can be achieved by the autonomous on-road vehicle 10 through applying breaks, through locking of some or all of its wheels, through abrupt steering movements of the front wheels, through application of the hand brake, through aggressive acceleration, and through using combinations of the above. In most cases, there is a very short time for the autonomous on-road vehicle 10 to accomplish such a maneuver, and perhaps shorter than one second or even a fraction of a second. The entire control of the maneuver is completely autonomous, as it is beyond the capability of a human being to achieve a necessary accuracy in positioning during such a short period of time and given that the entire collision scenario evolves too fast for a human being to plan such an intricate maneuver. During such a maneuver/adaptation 10-adapt, the autonomous on-road vehicle 10 may use various sensors, such as 4, to determine its accurate position and orientation relative to the foreign object 99, and to therefore adjust in real-time such an adaptation in order to accurately orient and position the autonomous on-road vehicle 10 for collision in the particular and selected point of impact.

During spinning or sliding, the velocity vector 10-move could still be pointing toward the approaching foreign object 99, while the orientation is toward a different direction. In other words, momentum (inertia) may still move the autonomous on-road vehicle 10 toward the approaching foreign object, but the autonomous on-road vehicle may now face a totally different direction, such as 10-or-2.

FIG. 1C illustrates one embodiment of the autonomous on-road vehicle 10 colliding 10-99 with the foreign object 99 in a particular way facilitated by the adapted orientation. After adapting 10-adapt to the new orientation 10-or-2 (FIG. 1B), the autonomous on-road vehicle 10 collides 10-99 with the foreign object 99 at the planned point of impact 10-spot, which is relatively distant from the passenger 9. The point of impact 10-spot could be achieved to within an accuracy of at least 30 (thirty) centimeters using autonomous real-time navigation, thereby giving the autonomous on-road vehicle 10 an accurate control over the collision process.

FIG. 1D illustrates one embodiment of the autonomous on-road vehicle 10 adapting differently the current orientation 10-or-1 in anticipation of the unavoidable collision with the foreign object 99. The autonomous on-road vehicle 10 may alternatively decide to spin backward, and to collide with the foreign object 99 through a rear section of the autonomous on-road vehicle. Adapting 10-adapt orientation 10-or-1 to orientation 1-or-3 brings the passenger 9 away from an expected point of impact. Other advantages of such a backward spin maneuver could be: reducing a relative velocity between the autonomous on-road vehicle 10 and the foreign object 99, and accelerating the passenger 9 away from a steering wheel at the instant of impact (i.e., at the time of impact, the passenger 9 will be pushed backward against the back of his seat instead of forward).

FIG. 1E illustrates one embodiment of the autonomous on-road vehicle 10 colliding 10-99 with the foreign object 99 in a different way facilitated by the orientation adapted differently. After adapting 10-adapt to the new orientation 10-or-3 (FIG. 1D), the autonomous on-road vehicle 10 collides 10-99 with the foreign object 99 at the planned point of impact 10-spot, which is at the rear of the autonomous on-road vehicle 10, and which is relatively distant from the passenger 9.

FIG. 1F illustrates one embodiment of the autonomous on-road vehicle 10 adapting a current trajectory thereof 10-move in anticipation of the unavoidable collision with the foreign object 99. The autonomous on-road vehicle 10 may alternatively decide to keep its heading, but to only shift its path to the right, and to collide with the foreign object 99 through a front-left section of the autonomous on-road vehicle. Adapting/shifting 10-adapt path/vector 10-move to path 10-move-2 brings the passenger 9 away from an expected point of impact.

FIG. 1G illustrates one embodiment of the autonomous on-road vehicle 10 colliding 10-99 with the foreign object 99 in a certain way facilitated by the adapted trajectory 10-move-2. After adapting/shifting 10-adapt to the new path/trajectory (FIG. 1F), the autonomous on-road vehicle 10 collides 10-99 with the foreign object 99 at the planned point of impact 10-spot, which is at the front-right of the autonomous on-road vehicle 10, and which is relatively distant from the passenger 9.

FIG. 1H illustrates one embodiment of a method for reducing or avoiding injuries in conjunction with an imminent collision of an autonomous on-road vehicle with a foreign object. The method includes: In step 1001, detecting 4-det (FIG. 1A), using sensors 4 onboard an autonomous on-road vehicle 10 currently moving 10-move, a foreign object 99 approaching 99-apr the autonomous on-road vehicle 10. In step 1002, predicting, by the autonomous on-road vehicle 10, based on said detection 4-det and related data processing, that said foreign object 99 is about to collide with the autonomous on-road vehicle 10. In step 1003, identifying positions of all passengers 9 in the autonomous on-road vehicle 10. In step 1004, adapting 10-adapt (FIG. 1B) autonomously a current trajectory or orientation 10-or-1 of the autonomous on-road vehicle 10, based on said prediction and identification, so as to cause the autonomous on-road vehicle 10 to collide 10-99 (FIG. 1C) with the foreign object 99 in a particular spot 10-spot (FIG. 1C) or orientation of the autonomous on-road vehicle 10 that is likely to reduced or avoid injury to the passengers 9.

In one embodiment, said identification comprises identifying a passenger 9 seating on a left-hand side of the autonomous on-road vehicle 10 and identifying that no passenger is seating on a right-hand side of the autonomous on-road vehicle 10; and said adaptation 10-adapt (FIG. 1B) comprises adapting the current orientation 10-or-1 of the autonomous on-road vehicle 10 (e.g., orientation 10-or-1 is adapted into orientation 1-or-2) so as to cause the right-hand side of the autonomous on-road vehicle to collide 10-99 (FIG. 1C) with the foreign object 99 (FIG. 1C), in which the particular spot is a spot 10-spot (FIG. 1C) located at the right-hand side of the autonomous on-road vehicle. In one embodiment, said collision 10-99 occurs no more than 1 (one) seconds after said prediction, thereby preventing the autonomous on-road vehicle 10 from avoiding the collision 10-99.

In one embodiment, said prediction comprises predicting that the foreign object 99 is about to collide with a front side of the autonomous on-road vehicle (FIG. 1A); said identification comprises identifying a passenger 9 seating in a front seat of the autonomous on-road vehicle 10 and identifying that no passenger is seating in a back seat of the autonomous on-road vehicle; and said adaptation 10-adapt (FIG. 1D) comprises adapting the current orientation 10-or-1 of the autonomous on-road vehicle 10 (e.g., orientation 10-or-1 is adapted into orientation 1-or-3) so as to rotate the autonomous on-road vehicle 10 and cause a back side of the autonomous on-road vehicle to collide 10-99 (FIG. 1E) with the foreign object 99, in which the particular spot is a spot 10-spot (FIG. 1E) located at the back side of the autonomous on-road vehicle.

In one embodiment, said prediction comprises predicting that the foreign object 99 is about to collide with a front-left side of the autonomous on-road vehicle (FIG. 1A); said identification comprises identifying a passenger 9 seating in a front-left seat of the autonomous on-road vehicle 10 and identifying that no passenger is seating in a front-right seat of the autonomous on-road vehicle; and said adaptation 10-adapt (FIG. 1F) comprises adapting the current trajectory 10-move of the autonomous on-road vehicle 10 (e.g., current trajectory 10-move is adapted into new trajectory 10-move-2) so as to cause a front-right side of the autonomous on-road vehicle to collide 10-99 (FIG. 1G) with the foreign object.

In one embodiment, said collision 10-99 occurs no more than 2 (two) seconds after said prediction, thereby preventing the autonomous on-road vehicle 10 from avoiding the collision.

In one embodiment, said detection comprises detecting the foreign object 99 suddenly entering into a lane on which the autonomous on-road vehicle 10 currently moves.

In one embodiment, said detection comprises detecting the foreign object 99 suddenly stopping in front of the autonomous on-road vehicle 10.

In one embodiment, said sudden stop is caused by the foreign object 99 being involved in a car accident.

In one embodiment, said prediction comprises predicting that any attempt for a collision-avoiding maneuver by the autonomous on-road vehicle 10 would have taken too long to actually avoid the collision.

In one embodiment, said prediction comprises predicting that any attempt for a collision-avoiding maneuver by the autonomous on-road vehicle 10 would have caused catastrophic damage to either the autonomous on-road vehicle 10, the foreign object 99, or to another object in the vicinity.

In one embodiment, said prediction that said foreign object 99 is about to collide with the autonomous on-road vehicle, is made by the autonomous on-road vehicle 10, as a result of the autonomous on-road vehicle concluding that the accident is inevitable and that any maneuver will not prevent the collision.

In one embodiment, said prediction that said foreign object 99 is about to collide with the autonomous on-road vehicle, is made by the autonomous on-road vehicle 10, as a result of the autonomous on-road vehicle concluding that the accident is avoidable, and that a maneuver could prevent the collision, but such a maneuver would cause damage in conjunction with hitting another object.

One embodiment is a system operative to reduce or avoid injuries in conjunction with an imminent collision of an autonomous on-road vehicle with a foreign object. The system includes an autonomous on-road vehicle 10 and sensors 4 onboard the autonomous on-road vehicle. The system is configured to cause the autonomous on-road vehicle 10 to collide with a foreign object 99 in a particular spot or orientation of the autonomous on-road vehicle 10 that is likely to reduced or avoid injury to a passenger 9.

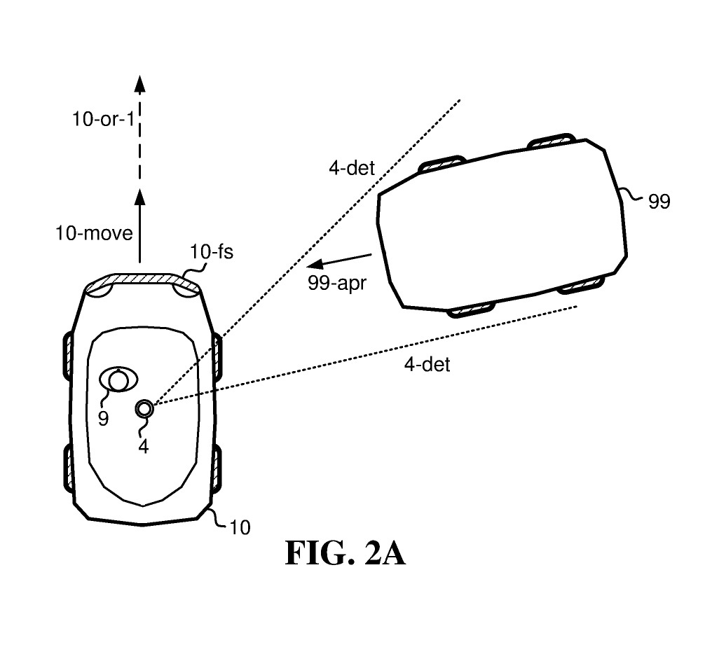

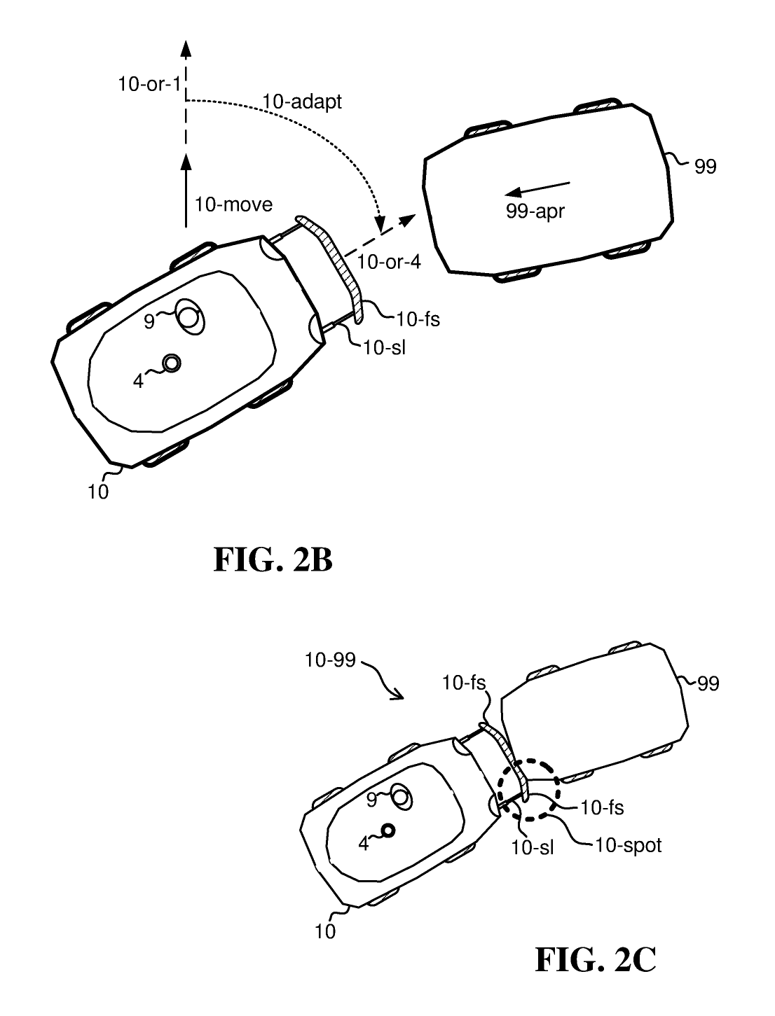

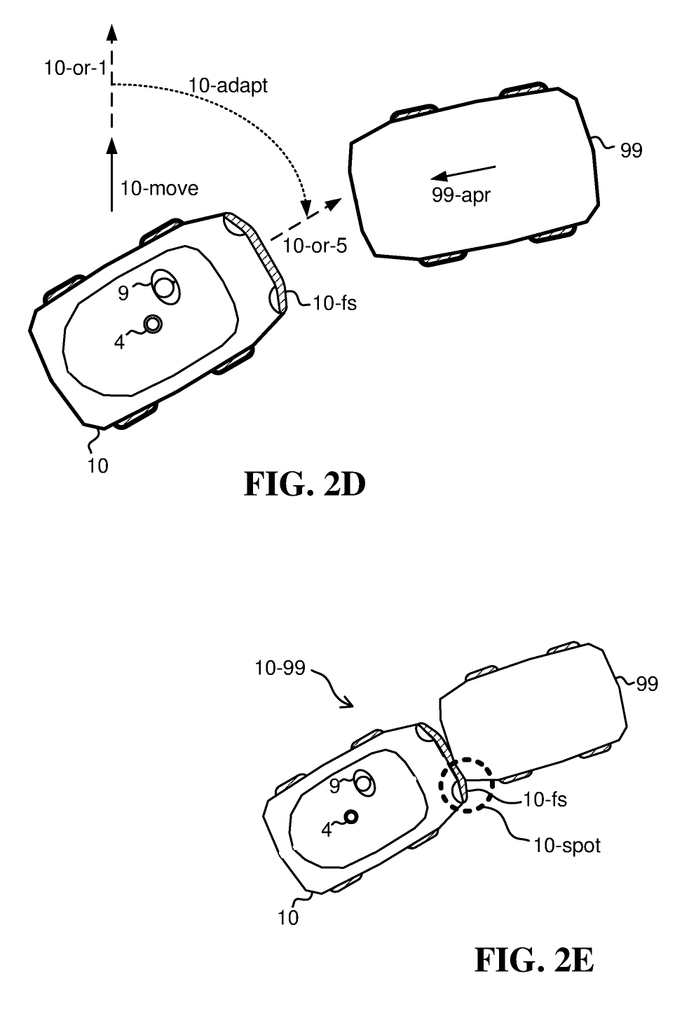

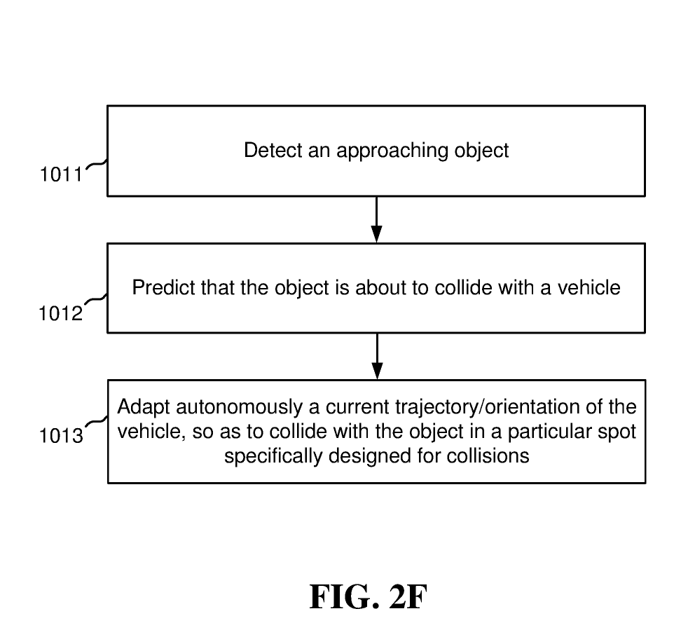

FIG. 2A illustrates one embodiment of an autonomous on-road vehicle 10 detecting 4-det a foreign object 99 approaching 99-apr. The autonomous on-road vehicle 10 is shown to include a front section 10-fs that is specifically designed to absorb or withstand the impact of a collision. The autonomous on-road vehicle 10 moves in a certain direction 10-move, and is oriented in a particular way 10-or-1. The autonomous on-road vehicle 10 analyzes the foreign object 99 trajectory 99-apr, the certain direction 10-move, and particular orientation 10-or-1, and then concludes that (i) a collision with foreign object 99 is inevitable or necessary, and that (ii) an active action needs to be taken in order to cause the collision to take place via the front section 10-fs.

FIG. 2B illustrates one embodiment of the autonomous on-road vehicle 10 adapting a current orientation thereof and deploying a spring-like mechanism in anticipation of an unavoidable collision with the foreign object 99. The autonomous on-road vehicle 10 will now take the active action needed to cause the collision to take place via the front section 10-fs, by adapting 10-adapt orientation from 10-or-1 to 10-or-4, and thereby causing the front section 10-fs to face the approaching foreign object 99. The adaptation 10-adapt from 10-or-1 to 10-or-4 is done by autonomously turning, spinning, or sliding toward the approaching foreign object 99. The front section 10-fs may include or be associated with a mechanism operative to reduce the impact of a collision, such as a spring like mechanism 10-sl. In such a case, the autonomous on-road vehicle 10 will autonomously deploy the mechanism just before the impact, and possibly during the adaptation process 10-adapt. As shown, the spring like mechanism 10-sl is deployed, thereby bringing the front section 10-fs away from the rest of the autonomous on-road vehicle 10, and away from the passenger 9.

FIG. 2C illustrates one embodiment of the autonomous on-road vehicle 10 colliding 10-99 with the foreign object 99 via the spring-like mechanism 10-sl, 10-fs. After completing the maneuver/adaptation 10-adapt, and after deploying the spring-like mechanism in conjunction with the front section 10-sl, 10-fs, the autonomous on-road vehicle 10 is now ready for the collision. The collision 10-99 takes place via the front section 10-fs at a particular spot 10-spot as planned, and the deployed spring-like mechanism 10-sl reduces collision-induced forces on the autonomous on-road vehicle 10 and passenger 9. The spring-like mechanism 10-sl may operate as a sort of a cushion.

FIG. 2D illustrates one embodiment of the autonomous on-road vehicle 10 adapting the current orientation thereof and heading toward the foreign object 99 in anticipation of an unavoidable collision with the foreign object. If the autonomous on-road vehicle 10 doesn't have a spring-like mechanism, it may still take the active action needed to cause the collision to take place via the front section 10-fs, by adapting 10-adapt orientation from 10-or-1 to 10-or-5, and thereby causing the front section 10-fs to face the approaching foreign object 99.

FIG. 2E illustrates one embodiment of the autonomous on-road vehicle 10 colliding 10-99 with the foreign object 99 head-on via a front section 10-fs of the autonomous on-road vehicle. After adapting 10-adapt orientation from 10-or-1 to 10-or-5 (FIG. 2D), the front section 10-fs faces the approaching foreign object 99, and collides with the foreign object 99. The front section 10-fs may be designed to collapse during the collision, or it may be particularly strong to withstand the collision, or it may be elastic and therefore reduce impact-induced forces on the passenger 9.

FIG. 2F illustrates one embodiment of a method for reducing or avoiding injuries in conjunction with an imminent collision of an autonomous on-road vehicle with a foreign object. The method includes: In step 1011, detecting 4-det (FIG. 2A), using sensors 4 onboard an autonomous on-road vehicle 10 currently moving 10-move, a foreign object 99 approaching the autonomous on-road vehicle. In step 1012, predicting, by the autonomous on-road vehicle 10, based on said detection 4-det and related data processing, that said foreign object 99 is about to collide with the autonomous on-road vehicle 10. In step 1013, adapting 10-adapt (FIG. 2B) autonomously a current trajectory or orientation 10-or-1 of the autonomous on-road vehicle 10, based on said prediction and detection 4-det, so as to cause the autonomous on-road vehicle 10 to collide 10-99 (FIG. 2C) with the foreign object 99 in a particular spot 10-spot (FIG. 2C) of the autonomous on-road vehicle 10 that is specifically designed to contain or at least reduce an impact of said collision.

In one embodiment, the particular spot 10-spot (FIG. 2C) comprises a spring-like mechanism 10-sl, 10-fs (FIG. 2B) operative to be deployed from a contracted position into an extracted position prior to the collision and as a result of said prediction.

In one embodiment, the particular spot 10-spot (FIG. 2E) comprises a front section 10-fs of the autonomous on-road vehicle operative to collapse during said collision.

In one embodiment, said prediction that said foreign object 99 is about to collide with the autonomous on-road vehicle, is made by the autonomous on-road vehicle 10, as a result of the autonomous on-road vehicle concluding that the accident is inevitable and that any maneuver will not prevent the collision.

In one embodiment, said prediction that said foreign object 99 is about to collide with the autonomous on-road vehicle, is made by the autonomous on-road vehicle 10, as a result of the autonomous on-road vehicle concluding that the accident is avoidable, and that a maneuver could prevent the collision, but such a maneuver would cause damage in conjunction with hitting another object.

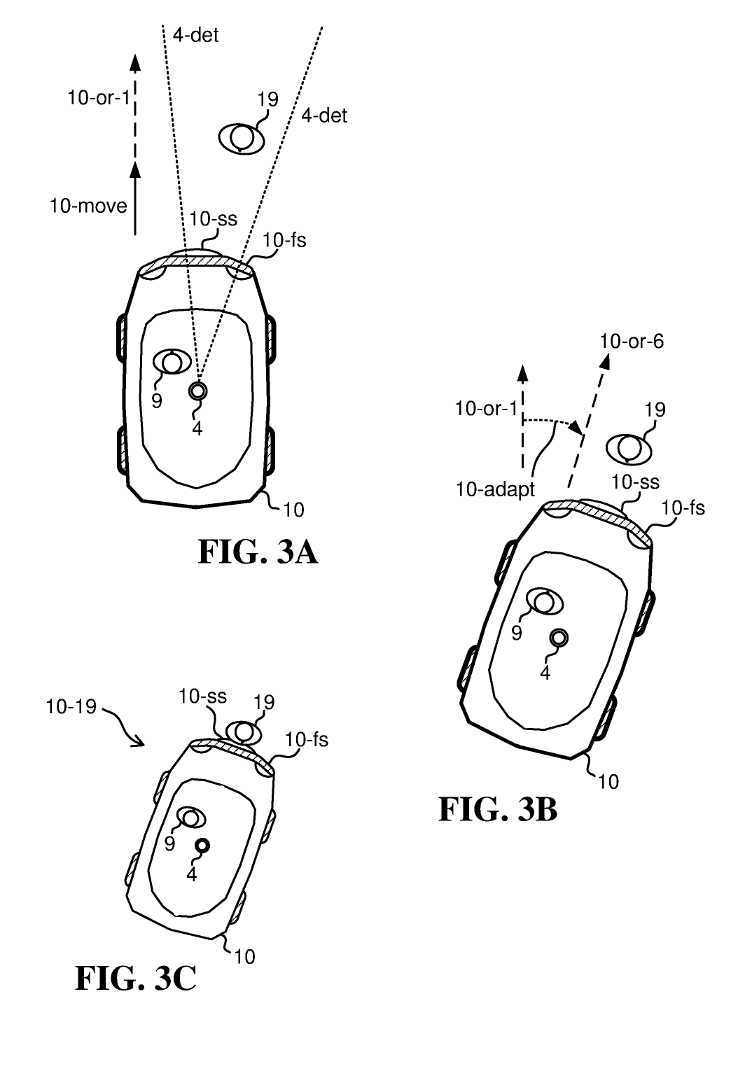

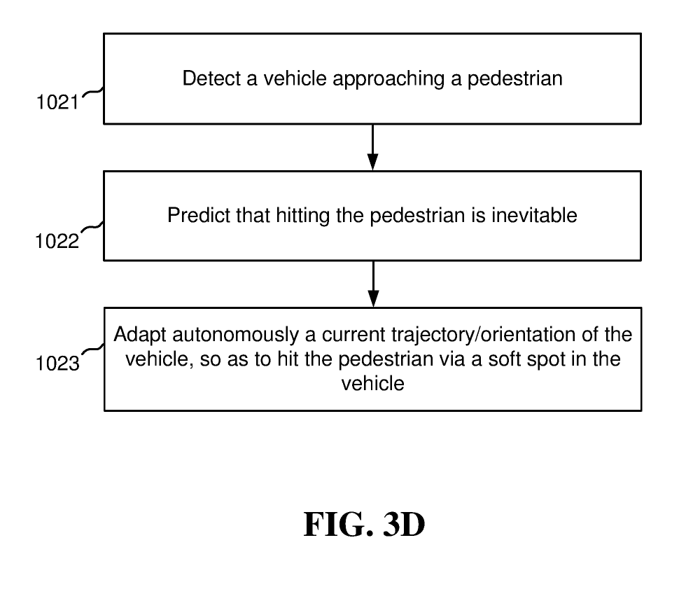

In one embodiment, the particular spot comprises a cushion 10-ss (FIG. 3C) operative to soften said collision.

In one embodiment, said cushion 10-ss is an inflatable cushion, operative to be deployed from a contracted position into an extracted position prior to the collision and as a result of said prediction.

One embodiment is a system operative to reduce or avoid injuries in conjunction with an imminent collision of an autonomous on-road vehicle with a foreign object. The system includes an autonomous on-road vehicle 10 having a particular spot that is specifically designed to contain or at least reduce an impact of said collision, and sensors 4 onboard the autonomous on-road vehicle. The system is configured to cause the autonomous on-road vehicle 10 to collide with the foreign object 99 in the particular spot of the autonomous on-road vehicle 10 that is specifically designed to contain or at least reduce an impact of said collision.

FIG. 3A illustrates one embodiment of an autonomous on-road vehicle 10 detecting 4-det that the autonomous on-road vehicle is approaching a pedestrian 19. The autonomous on-road vehicle 10 is shown to have a soft spot 10-ss associated with a front section 10-fs of the autonomous on-road vehicle. The soft spot 10-ss is operative to reduce forces induced on a pedestrian during a collision. The soft spot 10-ss may be any one or several of a cushion, a rubber section, an elastic polymer, or a spring of some sort. The autonomous on-road vehicle 10 concludes that hitting the pedestrian 19 is inevitable, but it also concludes that given current object dynamics, such as current velocity vector 10-move and current orientation 10-or-1, the autonomous on-road vehicle 10 will indeed hit the pedestrian 19, but not via the soft spot 10-ss. The autonomous on-road vehicle 10 therefore decides to adapt certain dynamics in order to make sure it hits the pedestrian via the soft spot 10-ss.

FIG. 3B illustrates one embodiment of the autonomous on-road vehicle 10 adapting 10-adapt a current orientation thereof and so as to position the soft spot 10-ss toward the pedestrian 19. The autonomous on-road vehicle 10 adapts its orientation from 10-or-1 to 10-or-6, by turning, spinning, or sliding itself toward the pedestrian 19. During such adaptation, the autonomous on-road vehicle 10 may reduce its velocity to an extent possible. At the end of such adaptation, the soft spot 10-ss is positioned toward the pedestrian 19.

FIG. 3C illustrates one embodiment of the autonomous on-road vehicle 10 colliding 10-19 with the pedestrian 19 via the soft spot. 10-ss. After adapting orientation from 10-or-1 to 10-or-6, the autonomous on-road vehicle 10 collides 10-19 with the pedestrian 19 via the soft spot 10-ss, thereby reducing collision induces forces on the pedestrian.

FIG. 3D illustrates one embodiment of a method for reducing or avoiding injuries in conjunction with an imminent collision of an autonomous on-road vehicle with a pedestrian. In step 1021, detecting 4-det (FIG. 3A), using sensors 4 onboard an autonomous on-road vehicle 10 currently moving 10-move, that the autonomous on-road vehicle is approaching a pedestrian 19. In step 1022, predicting, by the autonomous on-road vehicle 10, based on said detection 4-det and related data processing, that said approach is being made too fast to avoid hitting the pedestrian 19. In step 1023, adapting autonomously 10-adapt (FIG. 3B) a current trajectory or orientation 10-or-1 of the autonomous on-road vehicle 10, based on said prediction and detection 4-det, so as to cause the autonomous on-road vehicle 10 to collide 10-19 (FIG. 3C) with the pedestrian 19 in a particular soft spot 10-ss (FIG. 3C) of the autonomous on-road vehicle 10 that is specifically designed to contain or at least reduce an impact of said collision on the pedestrian 19.

In one embodiment, the particular soft spot 10-ss comprises a cushion or another soft element. In one embodiment, said cushion 10-ss is an inflatable cushion, which inflates upon said detection 4-det and prediction. In one embodiment, said cushion 10-ss is a static cushion.

In one embodiment, the particular soft spot comprises a spring-like mechanism operative to be deployed from a contracted position into an extracted position prior to the collision and as a result of said prediction.

In one embodiment, the particular soft spot comprises a front section of the car operative to collapse during said collision.

One embodiment is a system operative to reduce or avoid injuries in conjunction with an imminent collision of an autonomous on-road vehicle with a pedestrian. The system includes an autonomous on-road vehicle 10 having a particular soft spot that is specifically designed to contain or at least reduce an impact of said collision on the pedestrian 19, and sensors 4 onboard the autonomous on-road vehicle. The system is configured to cause the autonomous on-road vehicle 10 to collide with the pedestrian 19 in the particular soft spot of the autonomous on-road vehicle 10 that is specifically designed to contain or at least reduce an impact of said collision on the pedestrian 19.

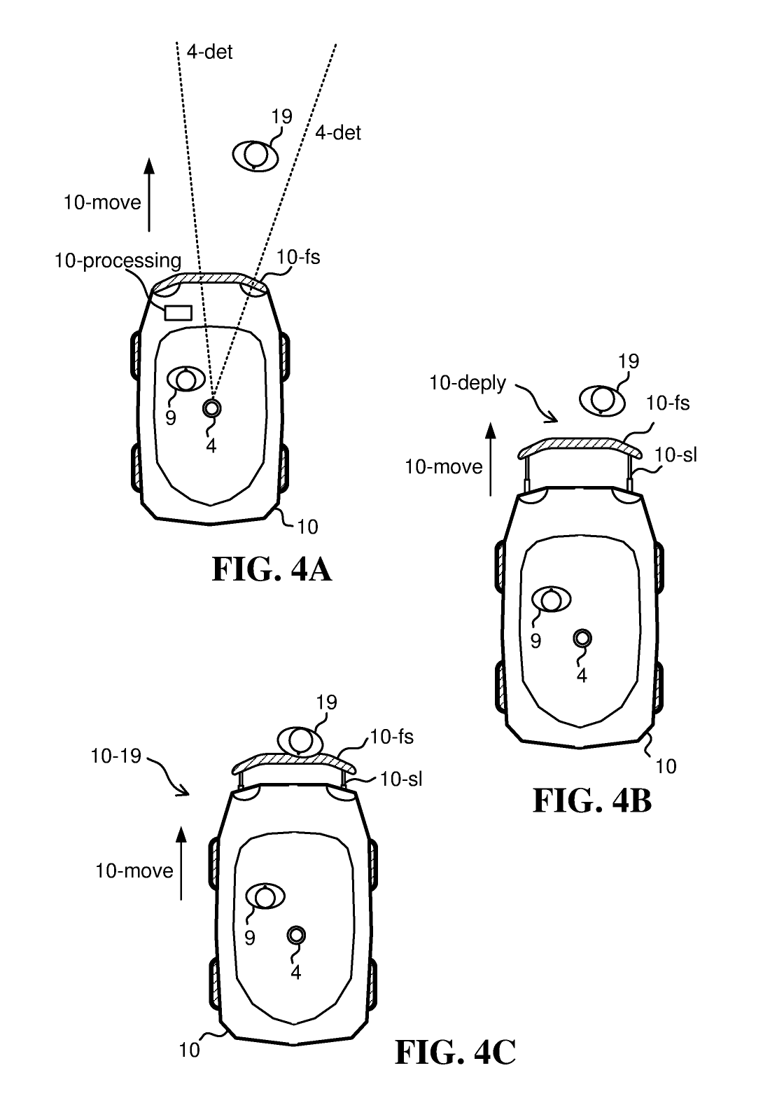

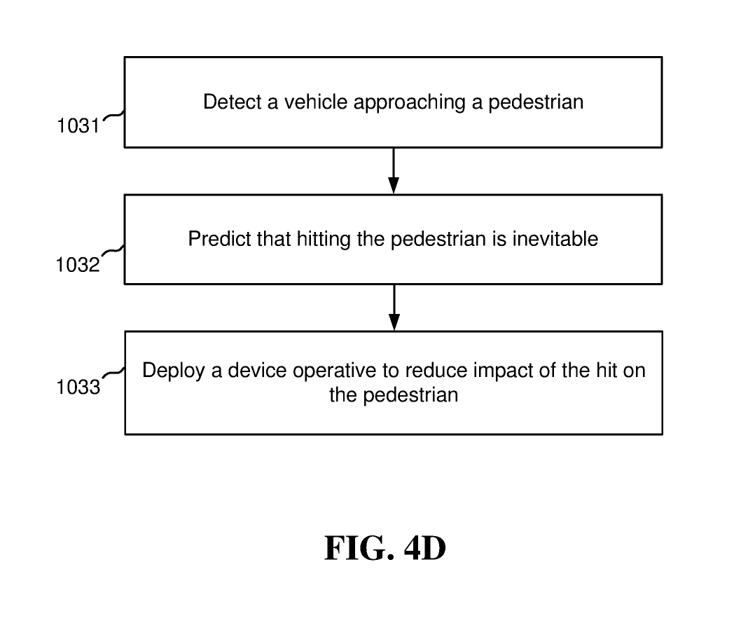

FIG. 4A illustrates one embodiment of a vehicle 10 detecting 4-det that the vehicle is approaching 10-move a pedestrian 19. Such detection is facilitated by a sensor 4 and a related data processing 10-processing, and consequently, the vehicle 10 may conclude that hitting the pedestrian 19 is inevitable. The vehicle 10 is shown with a front section 10-fs that is associated with a collision mitigation mechanism, such as a spring-like mechanism.

FIG. 4B illustrates one embodiment of the vehicle 10 deploying 10-deploy the spring-like mechanism 10-sl, 10-fs in anticipation of the unavoidable collision with the pedestrian 19. The front section 10-fs is pushed forward by the spring-like mechanism 10-fs, and is now in an extracted mode and ready for the collision.

FIG. 4C illustrates one embodiment of the vehicle 10 colliding 10-19 with the pedestrian 19 via the spring-like mechanism 10-sl, 10-fs and consequently reducing collision induced forces on the pedestrian. The spring-like mechanism 10-sl, 10-fs acts like a cushion for the pedestrian 19.

FIG. 4D illustrates one embodiment of a method for reducing or avoiding injuries in conjunction with an imminent collision of a vehicle with a pedestrian. In step 1031, detecting 4-det (FIG. 4A), using sensors 4 onboard a vehicle 10 currently moving 10-move, that the vehicle is approaching a pedestrian 19. In step 1032, predicting, by the vehicle 10, based on said detection 4-det and related data processing, that said approach is being made too fast to avoid hitting the pedestrian 19. In step 1033, deploying 10-deply (FIG. 4B), as a response to said prediction, a device 10-fs, 10-sl operative to reduce impact of said collision, by cushioning said hit of the vehicle 10 with the pedestrian 19.

In one embodiment, the device 10-fs, 10-sl comprises a spring-like mechanism 10-sl operative to be deployed 10-deply (FIG. 4B) from a contracted position (FIG. 4A) into an extracted position (FIG. 4B) prior to the collision and as a result of said prediction. In one embodiment, said cushioning of said hit is achieved by a flexibility of said device 10-fs, 10-sl in conjunction with said spring-like mechanism 10-sl.

In one embodiment, the device comprises an inflatable cushion, which inflates upon said detection 4-det and prediction.

One embodiment is a system configured to reduce or avoid injuries in conjunction with an imminent collision of a vehicle with a pedestrian. The system includes an autonomous on-road vehicle 10 having a device operative to reduce impact of said collision, by cushioning said hit of the vehicle 10 with the pedestrian 19, and sensors 4 onboard the autonomous on-road vehicle. The system is configured to deploy the device operative to reduce impact of said collision, in which such reduction is achieved by cushioning said hit of the vehicle 10 with the pedestrian 19.

One embodiment is a system operative to reduce collision induced forces, comprising. The system include: (i) a spring-like mechanism 10-fs, 10-sl (FIG. 4A, FIG. 4B, FIG. 4C) located in a front section 10-fs of an autonomous on-road vehicle 10, in which the spring-like mechanism 10-fs, 10-sl has at least two positions: a contracted position (as shown in FIG. 4A), and an extracted position (an shown in FIG. 4B), in which the spring-like mechanism 10-fs, 10-sl, when deployed in the extracted position, is operative to mechanically buffer the autonomous on-road vehicle 10 from a foreign object (e.g., 19, or e.g., 99) colliding with the spring-like mechanism 10-fs, 10-sl, and (ii) a plurality of sensors 4 and an associated data processing mechanism 10-processing (FIG. 4A), all belonging to the autonomous on-road vehicle 10, in which the plurality of sensors and the associated data processing mechanism are operative to detect 4-det the foreign object (e.g., 19, or e.g., 99) approaching the autonomous on-road vehicle, and predict, based on said detection, that said foreign object is about to collide with the autonomous on-road vehicle.

In one embodiment, the spring-like mechanism 10-fs, 10-sl is configured to be kept in the contracted position (FIG. 4A) during normal operation of the autonomous on-road vehicle 10; and upon said prediction being made, the spring-like 10-fs, 10-sl mechanism is configured to be deployed into the extracted position (10-fs, 10-sl, FIG. 4B), thereby forming said mechanical buffer, and reducing collision induced forces on the autonomous on-road vehicle in conjunction with the foreign object colliding (FIG. 4C, FIG. 2C).

In one embodiment, the spring-like mechanism, in the extracted position, has two modes: a hard mode associated with a higher K spring factor (FIG. 2B), and a soft mode associated with a lower K spring factor (FIG. 4B); the plurality of sensors 4 and the associated data processing mechanism 10-processing are further operative to determine whether or not said foreign object is a pedestrian 19; and upon determination that said foreign object is a pedestrian 19, said deployment of the spring-like mechanism is done in conjunction with the soft mode (FIG. 4B), thereby reducing or avoiding injuries to the pedestrian 19.

In one embodiment, the spring-like mechanism, in the extracted position, has two modes: a hard mode associated with a higher K spring factor (FIG. 2B), and a soft mode associated with a lower K spring factor (FIG. 4B); the plurality of sensors 4 and the associated data processing mechanism 10-processing are further operative to determine whether or not said foreign object is a pedestrian 19; and upon determination that said foreign object is not pedestrian (e.g., that the foreign object is another car 99), said deployment of the spring-like mechanism is done in conjunction with the hard mode (FIG. 2B), thereby reducing or avoiding injuries to passengers 9 in the autonomous on-road vehicle 10.

In one embodiment, said deployment of the spring-like mechanism 10-fs, 10-sl is done prior to the collision, such that the spring-like mechanism is fully deployed in the extracted position at a time of impact in conjunction with said collision. In one embodiment, said deployment is completed at least 0.5 seconds (half a second) prior to said impact.

In one embodiment, the system is configured to adapt autonomously 10-adapt (FIG. 2D) a current trajectory or orientation 10-or-1 of the autonomous on-road vehicle 10, based on said prediction, prior to said collision, so as to cause the autonomous on-road vehicle to collide with the foreign object (e.g., 99) via the spring-like mechanism now 10-fs, 10-sl in the extracted position (FIG. 2D). In one embodiment, said adaptation 10-adapt is done so as to position said front section 10-fs toward the foreign object 99, 19.

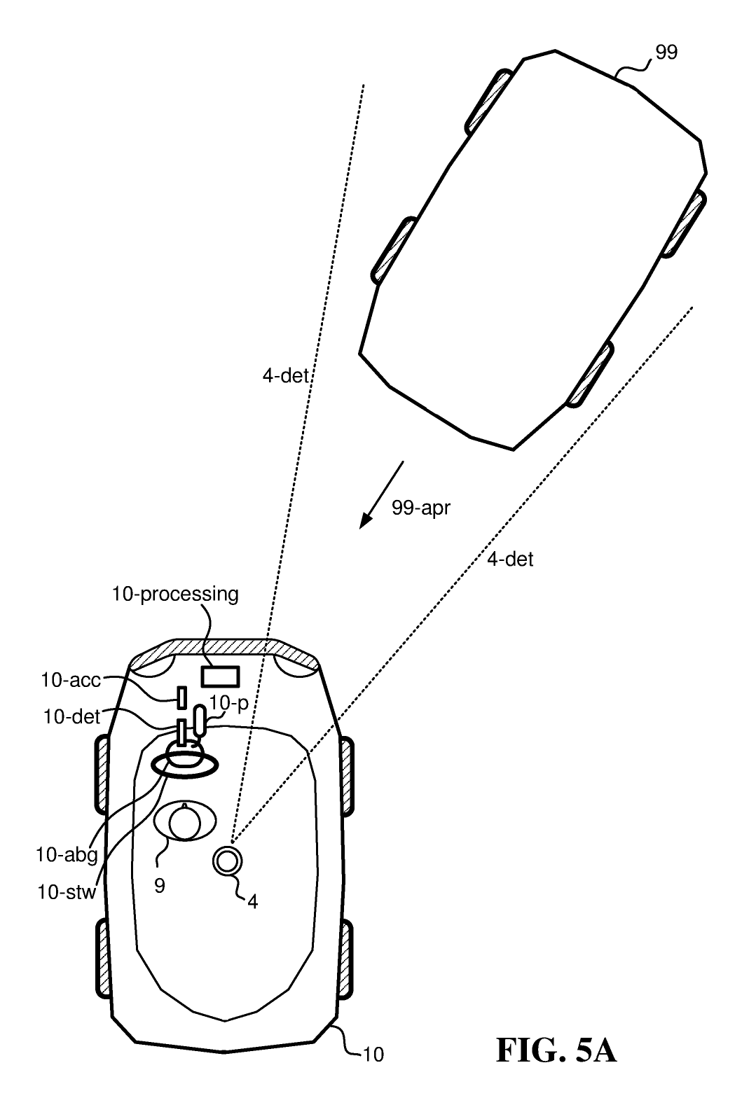

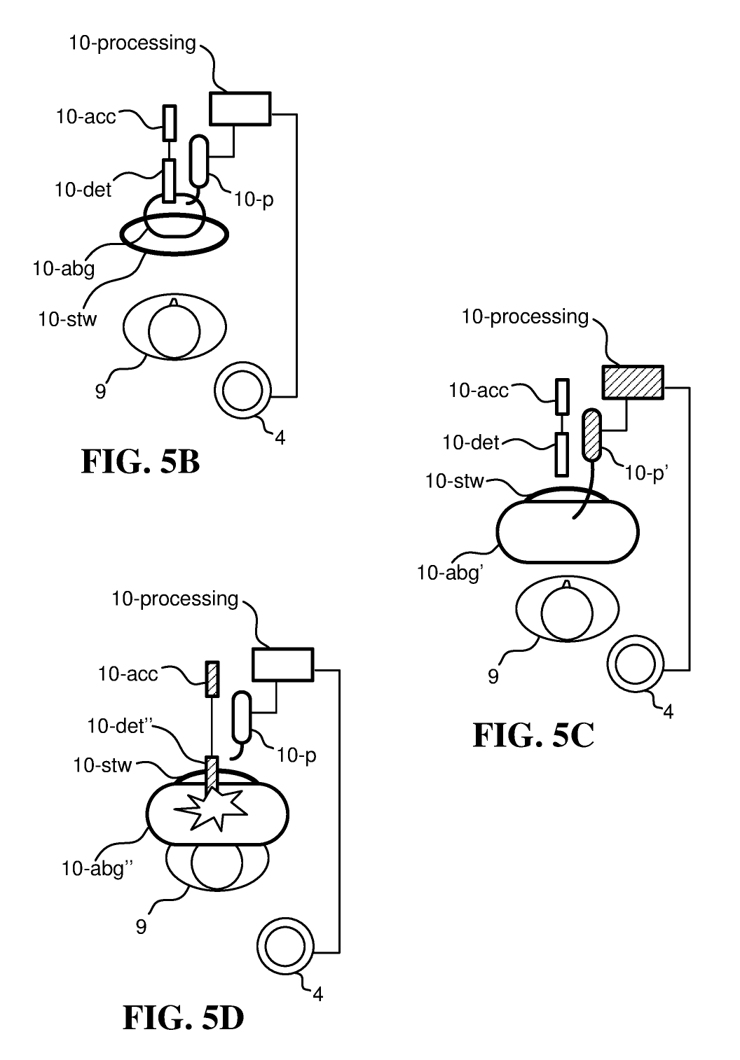

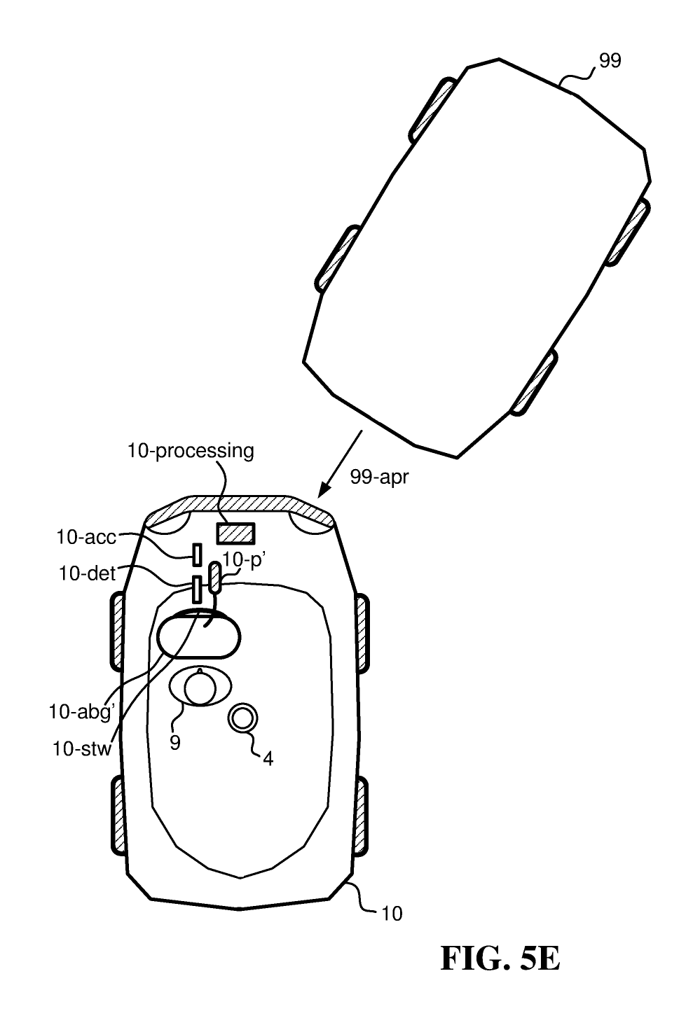

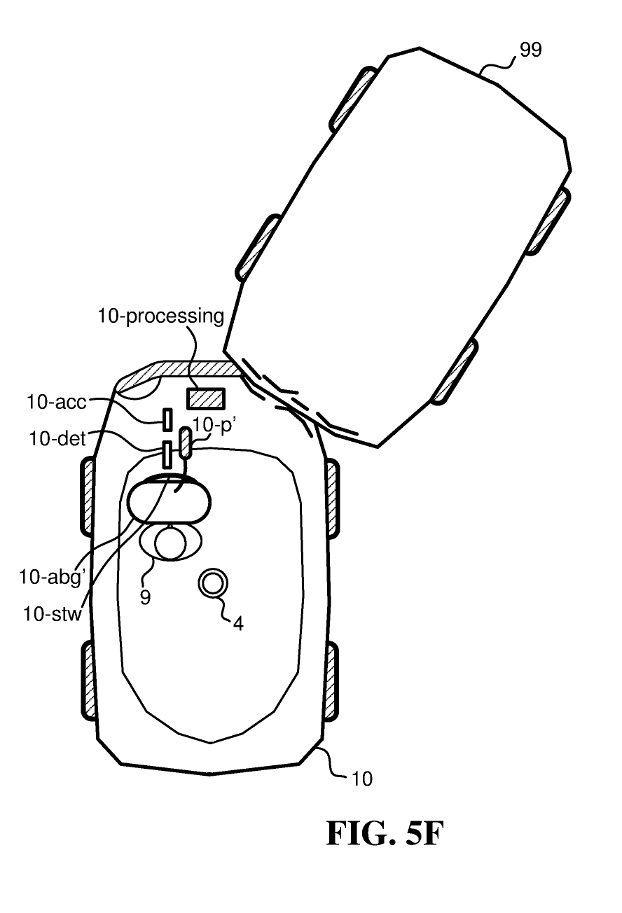

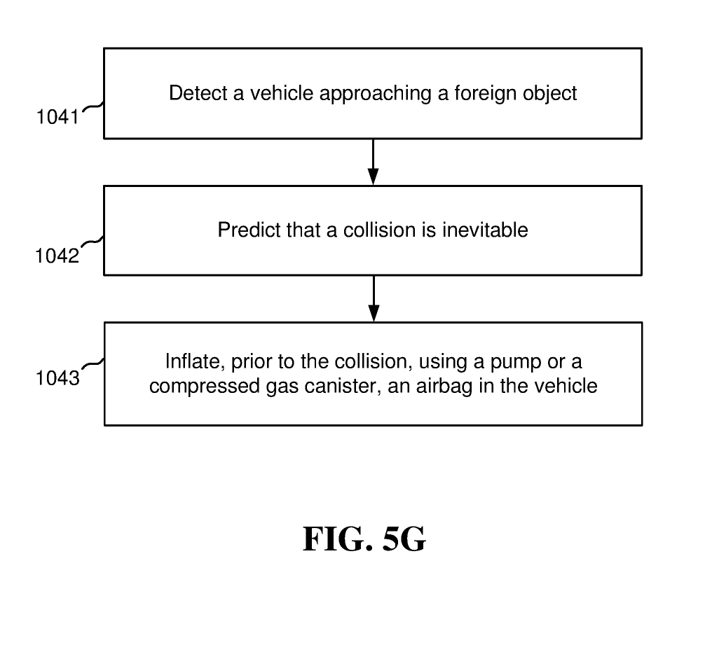

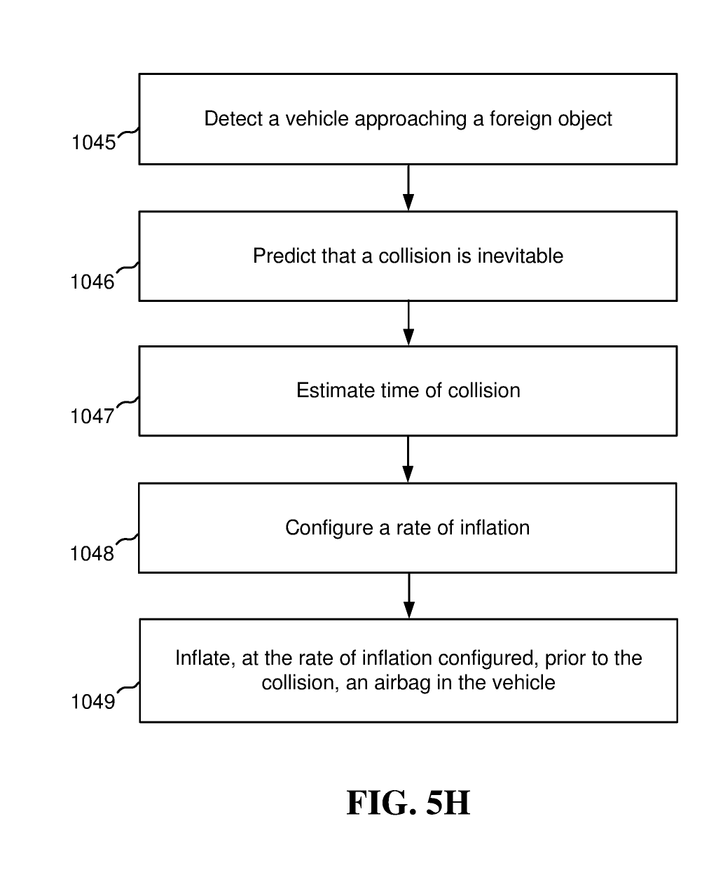

FIG. 5A illustrates one embodiment of a vehicle 10 detecting 4-det a foreign object 99 approaching 99-apr and predicting that a collision is inevitable. The vehicle 10 is shown to include a sensor 4 operative to facilitate the detection 4-det, a processing mechanism 10-processing operative to further facilitate the detection 4-det, an accelerometer 10-acc operative to sense an abrupt acceleration caused by a collision impact, an inflatable airbag 10-abg, a detonator 10-det operative to instantly inflate the airbag by means of a chemical reaction/detonation involving fast expanding gases such as nitrogen released by the ignition of sodium azide or nitroguanidine, a pump or a compressed air canister 10-p operative to inflate the airbag in a less aggressive manner than the detonator 10-det, a steering wheel 10-stw, and a passenger 9 seating in front of the steering wheel.

FIG. 5B illustrates one embodiment of an airbag mechanism inside the vehicle 10 prior to the collision between the vehicle and the foreign object 99, in which the airbag mechanism is still dormant. The airbag mechanism includes the sensor 4, the processing mechanism 10-processing, the accelerometer or a collision detector 10-acc, the inflatable airbag 10-abg, the detonator or another fast inflation mechanism 10-det, and the pump or compressed air canister or another slow inflation mechanism 10-p.

FIG. 5C illustrates one embodiment of the airbag mechanism inside the vehicle 10, in which an airbag 10-abg is inflated 10-abg′ as a result of predicting the collision but still prior to the actual collision. After detecting 4-det the foreign object 99 approaching 99-apr (FIG. 5A) and predicting that a collision is inevitable, the processing mechanism 10-processing decides to inflate the airbag 10-abg (now 10-abg′ indicating an inflated airbag), but instead of using the detonator 10-det to inflate the airbag via an aggressive detonation, the processing mechanism 10-processing instructs the pump or compressed air canister or another slow inflation mechanism 10-p to gently inflate the airbag, in which a gentle inflation can take between 200 milliseconds (one fifth of a seconds) and 2 (two) seconds. Unlike inflation by detonation, a gentle inflation is unlikely to cause damage to passenger's fingers, hands, or face. In addition, it is noted that the airbag 10-abg′ is now fully inflated before the collision has started, so that at this point in time there are no abrupt accelerations due to collision impact, and therefore the passenger's face is probably not even touching the already inflated airbag.

FIG. 5D illustrates one embodiment of the airbag mechanism in a fail-safe mode, in which the airbag 10-abg is inflated 10-abg″ as a result of actual collision forces, and in a scenario where the collision was not predicted by the vehicle 10. In a case that the processing mechanism 10-processing and sensor 4 together fail to predict the collision, then the airbag mechanism can still operate in a fail-safe mode, in which the airbag 10-agb″ is inflated by detonation 10-det″ as a result of abrupt acceleration induced by the actual collision and detected by the accelerometer or collision detector 10-acc.

FIG. 5E illustrates one embodiment of the vehicle 10 with the airbag 10-agb′ already inflated prior to the actual collision with the foreign object 99. The airbag 10-abg′ was gently inflated using the pump or compressed air canister 10-p, and the vehicle 10 is now ready for the collision.

FIG. 5F illustrates one embodiment of the vehicle 10 colliding with the foreign object 99 but with the airbag 10-abg′ already inflated. After the impact, the passenger's head will be forced into the now inflated airbag 10-abg′, but the airbag was not inflated into the passenger's head, which is often an unwanted outcome of inflating an airbag while the passenger's head is already forced into the airbag by collision induced forces.

One embodiment is a system having a dual-mode airbag inflation mechanism. The system includes: (i) at least a first airbag 10-abg (FIG. 5A) belonging to an autonomous on-road vehicle 10, (ii) a first accelerometer 10-acc inside the autonomous on-road vehicle 10, in which the first accelerometer is operative to sense an abrupt acceleration caused by a collision involving the autonomous on-road vehicle, (iii) a detonator 10-det associated with the first accelerometer 10-acc and the first airbag 10-abg, (iv) a plurality of sensors 4 and an associated data processing mechanism 10-processing, all belonging to the autonomous on-road vehicle 10, in which the plurality of sensors and the associated data processing mechanism are operative to detect 4-det a foreign object 99 approaching 99-apr (FIG. 5A) the autonomous on-road vehicle, and predict, based on said detection 4-det, that said foreign object 99 is about to collide with the autonomous on-road vehicle 10, and (v) a pump 10-p or a compressed gas canister associated with the data processing mechanism 10-processing and the first airbag 10-abg.

In one embodiment, in a first mode of operation: upon said sensing, the detonator 10-det is configured to detonate (FIG. 5D, 10-det″) and instantly inflate the first airbag (FIG. 5D, 10-abg″); and in a second mode of operation: upon said prediction being made, the pump 10-p or compressed gas canister is configured to slowly inflate the first airbag (FIG. 5C, 10-abg′), so as to cause the inflation process to take longer than 200 milliseconds (0.2 seconds) and therefore avoiding said detonation and instant inflation, and so as to cause the first airbag 10-abg to be fully inflated (FIG. 5C, 10-abg′) before said abrupt acceleration begins; thereby implementing said dual-mode airbag inflation mechanism.

In one embodiment, in the second mode of operation, when the first airbag 10-abg is fully inflated 10-abg′ before said abrupt acceleration begins (FIG. 5C, FIG. 5E), a passenger 9 inside the autonomous on-road vehicle 10 has a reduced chance of being injured by said inflation of the first airbag. In one embodiment, said slow inflation is further operative to reduce the chance of being injured by said inflation of the first airbag.

In one embodiment, the at least first airbag 10-abg is two airbags, in which one of the airbags is associated with the detonator 10-det, and the other airbag is associated with the pump 10-p or compressed gas canister.

In one embodiment, said instant inflation is an inflation that happens in less than 50 milliseconds (0.05 seconds).

FIG. 5G illustrates one embodiment of a method for safely inflating an airbag in anticipation of a collision. The method includes: In step 1041, detecting 4-det (FIG. 5A), using sensors 4 onboard a vehicle 10 currently moving, a foreign object 99 approaching 99-apr the vehicle. In step 1042, predicting, by the vehicle 10, based on said detection 4-det and related data processing 10-processing, that said foreign object 99 is about to collide with the vehicle 10. In step 1043, inflating (FIG. 5C), prior to the collision, using a pump 10-p, 10-p′ or a compressed gas canister, an airbag 10-abg, 10-abg′ in the vehicle 10, thereby colliding with the foreign object 99 while the airbag 10-abg is already inflated 10-abg.

In one embodiment, said inflation (FIG. 5C) is a slow inflation, in which the slow inflation is an inflation that takes between 200 milliseconds (0.2 second) and one second to be accomplish, thereby avoiding a need for a fast inflation (FIG. 5D) associated with detonating a detonator 10-det″ in conjunction with the airbag 10-abg, 10-abg″.

In one embodiment, said inflation (FIG. 5C) is a slow inflation, in which the slow inflation is an inflation that takes more than 200 milliseconds (0.2 second) to be accomplish.

FIG. 5H illustrates one embodiment of a method for safely inflating an airbag in anticipation of a collision. The method includes: In step 1045, detecting 4-det (FIG. 5A), using sensors 4 onboard a vehicle 10 currently moving, a foreign object 99 approaching 99-apr the vehicle. In step 1046, predicting, by the vehicle 10, based on said detection 4-det and related data processing 10-processing, that said foreign object 99 is about to collide with the vehicle 10. In step 1047, estimating, by the vehicle 10, based on said prediction and related data processing 10-processing (FIG. 5B), the time of collision of said foreign object 99 with the vehicle 10. In step 1048, configuring, by the vehicle 10, based on said estimated time of collision, a rate of inflation. In step 1049, inflating (FIG. 5C), at said rate of inflation configured, prior to the collision, an airbag 10-abg, 10-abg′ in the vehicle 10, thereby colliding with the foreign object 99 while the airbag 10-abg is already inflated 10-abg′.

One embodiment is a system having a dual-mode airbag inflation mechanism, comprising: at least a first airbag 10-abg (FIG. 5A) belonging to an autonomous on-road vehicle 10; a collision sensor 10-acc inside the autonomous on-road vehicle 10, in which said collision sensor is operative to sense a collision involving the autonomous on-road vehicle; a fast airbag inflator 10-det associated with the said collision sensor 10-acc and said first airbag 10-abg; a plurality of sensors 4 and an associated data processing mechanism 10-processing, all belonging to the autonomous on-road vehicle 10, in which the plurality of sensors and the associated data processing mechanism are operative to detect 4-det a foreign object 99 approaching 99-apr (FIG. 5A) the autonomous on-road vehicle, and predict, based on said detection 4-det, that said foreign object 99 is about to collide with the autonomous on-road vehicle 10; and a slow airbag inflator 10-p associated with the data processing mechanism 10-processing and the first airbag 10-abg.

In one embodiment, in a first mode of operation: upon said sensing of the collision, the fast airbag inflator 10-det is configured to instantly inflate (FIG. 5D, 10-det″) the first airbag (FIG. 5D, 10-abg″); and in a second mode of operation: upon said prediction being made, the slow airbag inflator 10-p is configured to slowly inflate the first airbag (FIG. 5C, 10-abg′), so as to cause the inflation process to take longer than 80 milliseconds (0.08 seconds) and therefore avoiding said instant inflation, and so as to cause the first airbag 10-abg to be at least partially inflated (FIG. 5C, 10-abg′) before said foreign object impact; thereby implementing said dual-mode airbag inflation mechanism.

In one embodiment, the slow airbag inflator 10-p comprises an air pump operative to facilitate said slow inflation.

In one embodiment, the slow airbag inflator 10-p comprises a gas canister operative to facilitate said slow inflation.

In one embodiment, the fast airbag inflator 10-det comprises a solid propellant or a detonator operative to facilitate said instant inflation of the airbag upon said sensing of the collision.

In one embodiment, the fast airbag inflator 10-det comprises a chemical reaction mechanism operative to facilitate said instant inflation of the airbag using a chemical reaction which is triggered upon said sensing of the collision.

In one embodiment, the fast airbag inflator 10-det and the slow inflator 10-p are both embedded in one dual-mode inflation device.

In one embodiment, the collision sensor 10-acc comprises an accelerometer operative to facilitate said detection of the collision.

In one embodiment, the collision sensor 10-acc comprises a pressure sensor or a mass-type sensor or a roller-type sensor operative to facilitate said detection of the collision.

In one embodiment, the second mode of operation, the first airbag 10-abg is fully inflated (FIG. 5C, 10-abg′) before said foreign object impact.

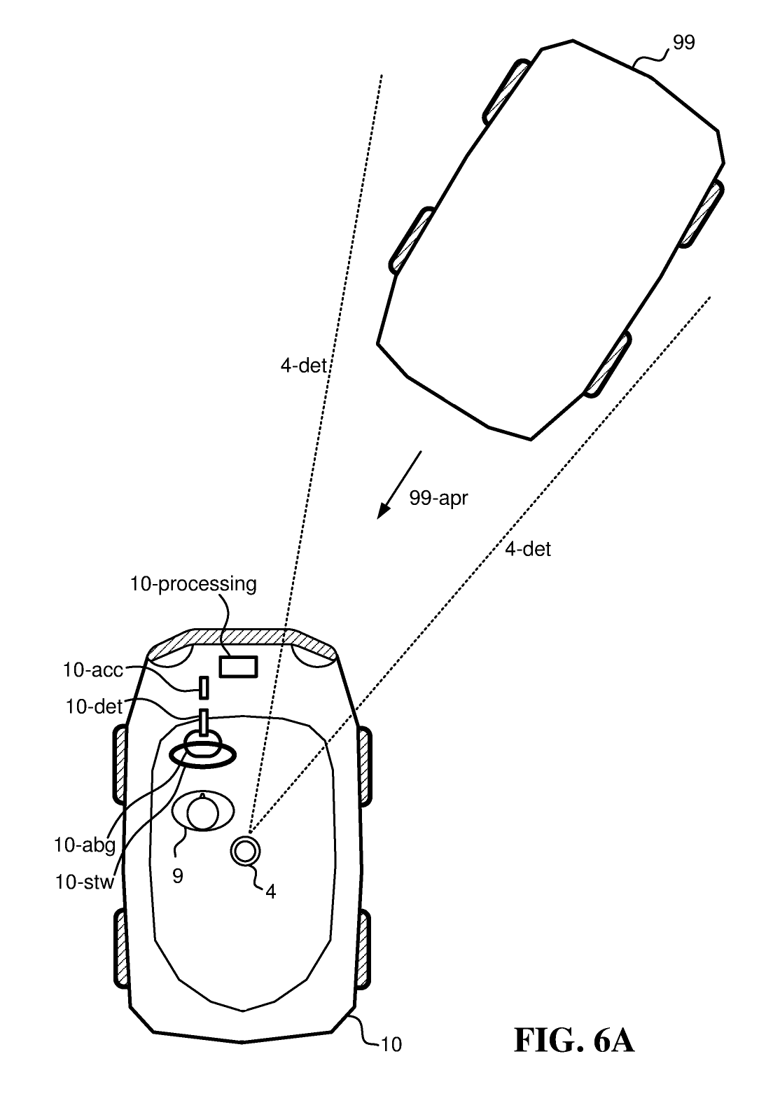

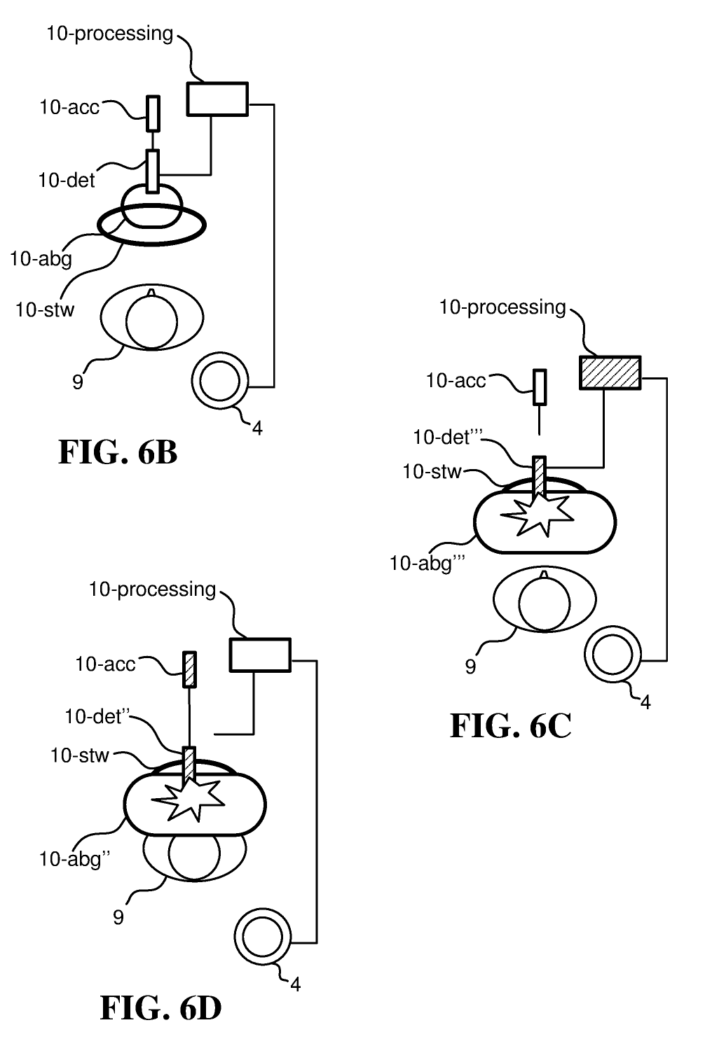

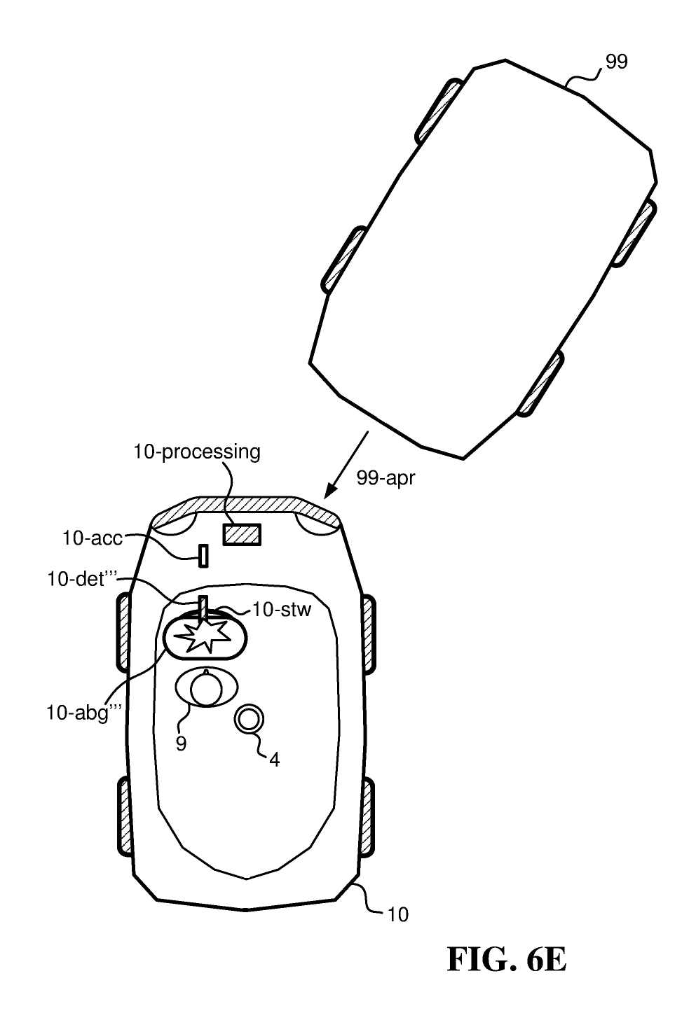

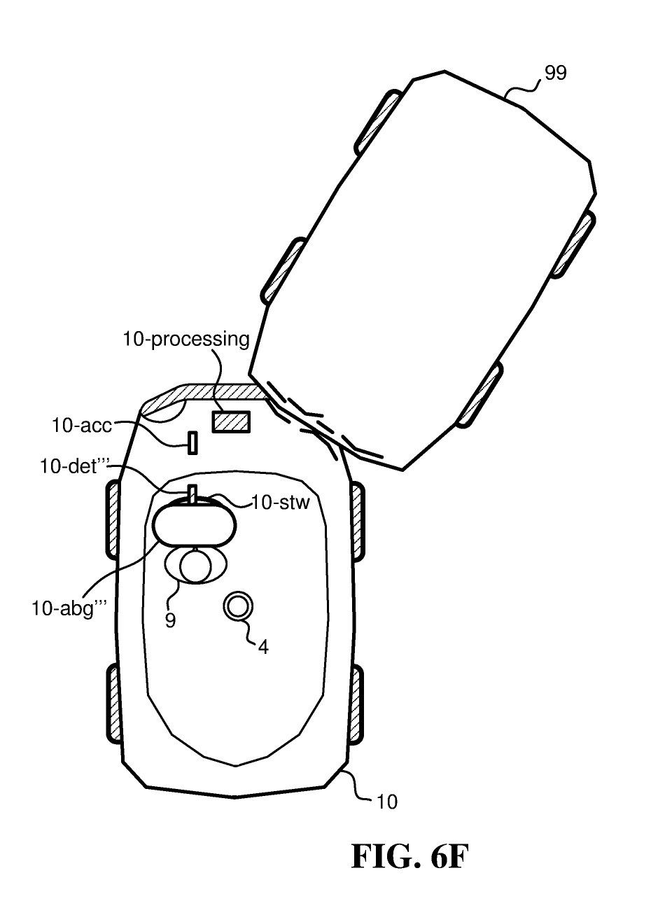

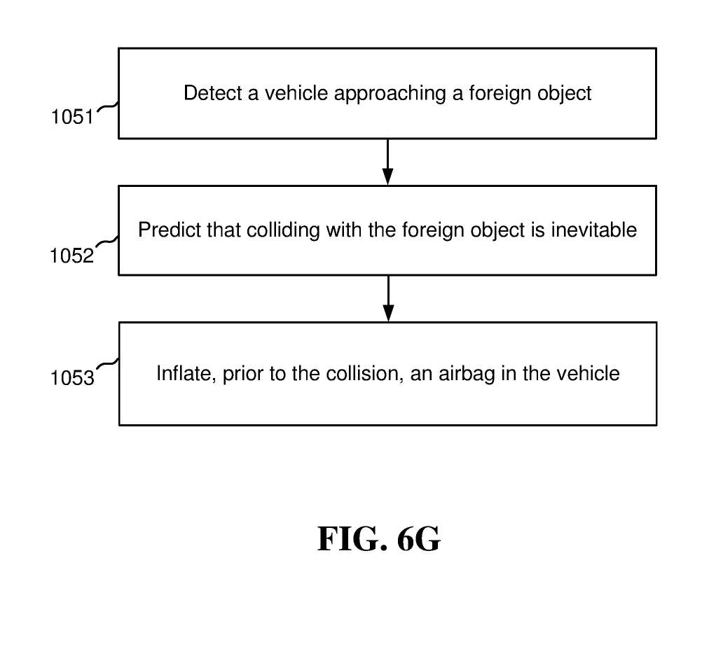

FIG. 6A illustrates one embodiment of a vehicle 10 detecting 10-det a foreign object 99 approaching 99-apr and predicting a collision. The vehicle 10 is shown to include a sensor 4 operative to facilitate the detection 4-det, a processing mechanism 10-processing operative to further facilitate the detection 4-det, an accelerometer or a collision detector 10-acc operative to sense an abrupt acceleration caused by a collision impact, an inflatable airbag 10-abg, a detonator 10-det operative to instantly inflate the airbag by means of detonation, a steering wheel 10-stw, and a passenger 9 seating in front of the steering wheel.

FIG. 6B illustrates one embodiment of an airbag mechanism inside the vehicle 10 prior to the collision between the vehicle and the foreign object 99, in which the airbag mechanism is still dormant. The airbag mechanism includes the sensor 4, the processing mechanism 10-processing, the accelerometer or collision detector 10-acc, the inflatable airbag 10-abg, and the detonator 10-det.

FIG. 6C illustrates one embodiment of the airbag mechanism inside the vehicle 10, in which an airbag 10-abg is inflated 10-abg′″ using the detonator 10-det′″ as a result of predicting the collision but still prior to the actual collision. After detecting 4-det the foreign object 99 approaching 99-apr (FIG. 6A) and predicting that a collision is inevitable, the processing mechanism 10-processing decides to inflate the airbag 10-abg (now 10-abg′″ indicating an inflated airbag) using the detonator 10-det′″. In addition, it is noted that the airbag 10-abg′″ is now fully inflated before the collision has started, so that at this point in time there are no abrupt accelerations due to collision impact, and therefore the passenger's face is probably not even touching the already inflated airbag.

FIG. 6D illustrates one embodiment of the airbag mechanism in a fail-safe mode, in which the airbag 10-abg is inflated 10-abg″ as a result of actual collision forces, and in a scenario where the collision was not predicted by the vehicle 10. In a case that the processing mechanism 10-processing and sensor 4 together fail to predict the collision, the airbag mechanism can still operate in a fail-safe mode, in which the airbag 10-agb″ is inflated by detonation 10-det″ as a result of abrupt acceleration induced by the actual collision and detected by the accelerometer or collision detector 10-acc.

FIG. 6E illustrates one embodiment of the vehicle 10 with the airbag already inflated 10-abg′″ prior to the actual collision with the foreign object 99. The airbag 10-abg′″ was inflated by a signal from the processing mechanism 10-processing induced by the detection 4-det (FIG. 6A), and not as a result of the accelerometer or collision detector 10-acc detecting collision induced forces. The vehicle 10 is now ready for the collision.

FIG. 6F illustrates one embodiment of the vehicle 10 colliding with the foreign object 99 but with the airbag already inflated 10-abg′″. After the impact, the passenger's head will be forced into the now inflated airbag 10-abg′″, but the airbag was not inflated into the passenger's head, which is often an unwanted outcome of inflating an airbag while the passenger's head is already forced into the airbag by collision induced forces.

One embodiment is a system having a dual-mode airbag inflation mechanism. The system includes: (i) at least a first airbag 10-abg (FIG. 6A) belonging to an autonomous on-road vehicle 10, (ii) a first accelerometer or a collision detector 10-acc inside the autonomous on-road vehicle 10, in which the first accelerometer or collision detector is operative to sense an abrupt acceleration caused by a collision involving the autonomous on-road vehicle, (iii) a detonator 10-det associated with the first accelerometer or collision detector 10-acc and the first airbag 10-abg, (iv) and a plurality of sensors 4 and an associated data processing mechanism 10-processing, all belonging to the autonomous on-road vehicle 10, in which the plurality of sensors and the associated data processing mechanism are operative to detect 4-det a foreign object 99 approaching 99-apr the autonomous on-road vehicle 10, and predict, based on said detection 4-det, that said foreign object 99 is about to collide with the autonomous on-road vehicle 10.

In one embodiment, in a first mode of operation: upon said sensing, the detonator 10-det is configured to detonate (FIG. 6D, 10-det″) and instantly inflate the first airbag (FIG. 6D, 10-abg″); and in a second mode of operation: upon said prediction being made, the detonator 10-det is configured to detonate (FIG. 6C, 10-det′″) and instantly inflate the first airbag (FIG. 6C, 10-abg′″) even though no sensing of said abrupt acceleration was made, and so as to cause the first airbag to be fully inflated (FIG. 6C, FIG. 6E, 10-abg′″) before said abrupt acceleration begins; thereby implementing said dual-mode airbag inflation mechanism.

In one embodiment, in the second mode of operation, when the first airbag is fully inflated before said abrupt acceleration begins (FIG. 6C, FIG. 6E, 10-abg′″), a passenger 9 inside the autonomous on-road vehicle has a reduced chance of being injured by said detonation of the detonator 10-det′″ and said inflation of the first airbag.

FIG. 6G illustrates one embodiment of a method for inflating an airbag in anticipation of a collision. In step 1051, detecting 4-det (FIG. 6A), using sensors 4 onboard a vehicle 10 currently moving, a foreign object 99 approaching 99-apr the vehicle. In step 1052, predicting, by the vehicle 10, based on said detection 4-det and related data processing 10-processing, that said foreign object 99 is about to collide with the vehicle 10. In step 1053, inflating (FIG. 6C), prior to the collision, an airbag 10-abg, 10-abg′″ in the vehicle 10, thereby colliding with the foreign object 99 while the airbag 10-abg is already inflated 10-abg′″.

In one embodiment, said collision with the foreign object 99, while the airbag is already inflated 10-abg′″, circumvents a situation in which a passenger's head (9, FIG. 6D) is already moving toward the airbag 10-abg prior to inflating the airbag 10-abg″, and thereby avoiding a need to detonate the airbag on the passenger's face (FIG. 6D).

One embodiment is a system having a dual-mode airbag inflation mechanism, comprising: at least a first airbag 10-abg (FIG. 6A) belonging to an autonomous on-road vehicle 10; a collision sensor 10-acc inside the autonomous on-road vehicle 10, in which said collision sensor is operative to sense a collision involving the autonomous on-road vehicle; an inflator 10-det associated with the first collision sensor 10-acc and the first airbag 10-abg; and a plurality of sensors 4 and an associated data processing mechanism 10-processing, all belonging to the autonomous on-road vehicle 10, in which the plurality of sensors and the associated data processing mechanism are operative to detect 4-det a foreign object 99 approaching 99-apr the autonomous on-road vehicle 10, and predict, based on said detection 4-det, that said foreign object 99 is about to collide with the autonomous on-road vehicle 10.

In one embodiment, in a first mode of operation: upon said sensing, the collision sensor 10-acc is configured to cause the inflator 10-det to instantly inflate (FIG. 6D, 10-det″) the first airbag (FIG. 6D, 10-abg″); and in a second mode of operation: upon said prediction being made, the inflator 10-det is configured to instantly inflate (FIG. 6C, 10-det″′) the first airbag (FIG. 6C, 10-abg′″) even though no sensing of said collision was made, and so as to cause the first airbag to be fully inflated (FIG. 6C, FIG. 6E, 10-abg′″) before said collision begins; thereby implementing said dual-mode airbag inflation mechanism.

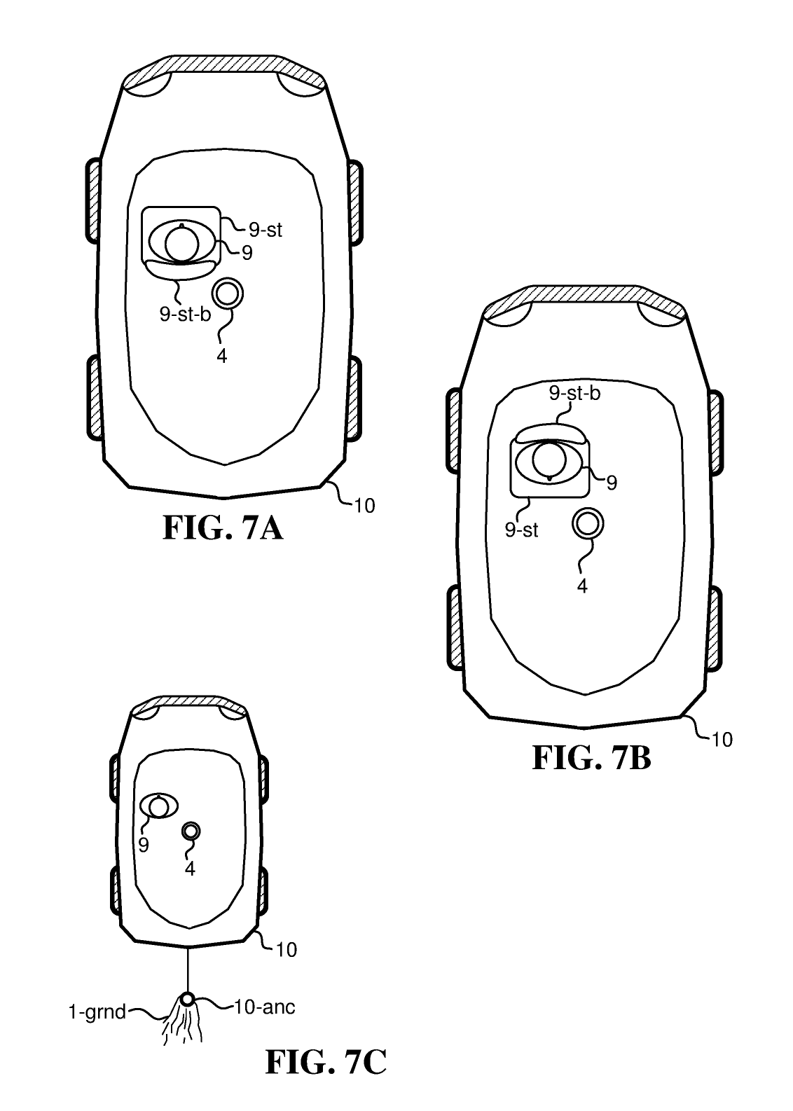

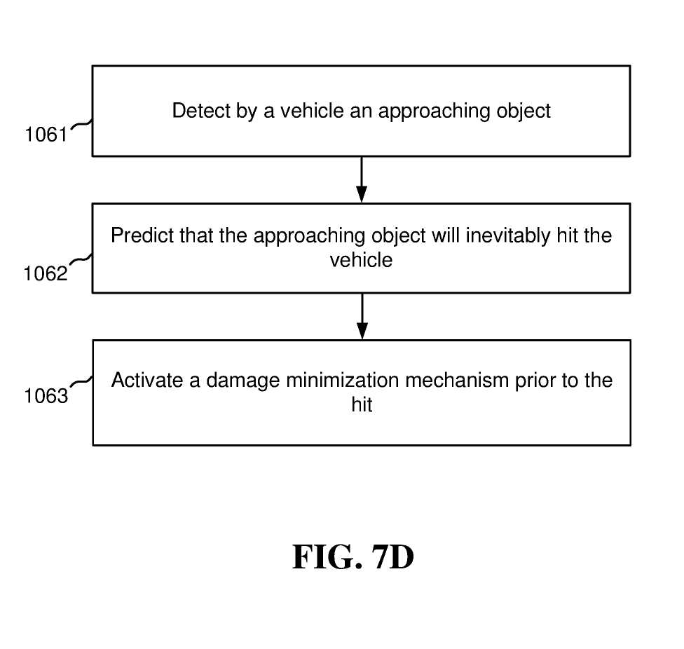

FIG. 7A illustrates one embodiment of a vehicle 10 with a passenger 9 seated in a certain way. The passenger 9 is shown to be seated facing front in a seat 9-st comprising a seat back 9-st-b. The vehicle detects (e.g., det-4, FIG. 1A) that a collision is inevitable.

FIG. 7B illustrates one embodiment of the vehicle 10 automatically changing the way the passenger 9 is seated as a result of an inevitable accident predicted by the vehicle. After predicting that a collision if inevitable, the seat 9-st is rotated so as to cause the passenger 9 to face away of the front, and thereby placing the seat back 9-st-b between the passenger 9 and the front of the car, in which the seat back 9-st-b can now shield the passenger from a frontal collision impact.

FIG. 7C illustrates one embodiment of the vehicle 10 automatically deploying an anchor or another device 10-anc in the ground 1-grnd, or to get in contact with the ground, as a result of an inevitable accident predicted by the vehicle. The anchor 10-anc is fired into the ground 1-grnd and thereby abruptly reducing a velocity of the vehicle 10, and thereby minimizing expected damage. Another device, such as a friction mass 10-anc, could be put in contact with the ground, produce friction, and thereby also cause said abrupt reduction in velocity.

FIG. 7D illustrates one embodiment of a method for activating a safety mechanism in anticipation of an imminent car accident. The method includes: In step 1061, detecting, by a sensor 4 onboard a moving vehicle 10, an approaching object 99 or 19. In step 1062, predicting, by the vehicle, based on said detection, that said approaching object is about to hit the vehicle. In step 1063, activating, as a result of said detection, in the vehicle, a damage minimization mechanism (e.g., 10-fs, 10-sl in FIG. 4B, or 10-abg′ in FIG. 5C, or 10-ss in FIG. 3B) operative to reduce crash damage, in which the damage minimization mechanism is deployed prior to said approaching object hitting the vehicle.

In one embodiment, said damage minimization mechanism comprises controlling vehicle trajectory (e.g., 10-adapt in FIG. 1F) to find optimal contact point between the vehicle and the approaching object, thereby minimizing expected damage.

In one embodiment, said damage minimization mechanism comprises controlling vehicle height to find optimal relative vehicle height between the vehicle and the approaching object, thereby minimizing expected damage.

In one embodiment, said damage minimization mechanism comprises controlling seat orientation to find optimal angle between passengers 9 and crash contact point, thereby minimizing expected damage (9-st, 9-st-b, FIG. 7A, FIG. 7B).

In one embodiment, said damage minimization mechanism comprises an anchor releasing device 10-anc, FIG. 7C, in which an anchor is fired into the ground 1-grng and thereby abruptly reducing a velocity of the vehicle, and thereby minimizing expected damage.

One embodiment is a system operative to activate a safety mechanism in anticipation of an imminent accident. The system includes a moving vehicle 10 having a sensor 4 onboard, and a damage minimization mechanism. The system is configured to activate as a result of a detection, in conjunction with the vehicle, the damage minimization mechanism operative to reduce crash damage, in which the damage minimization mechanism is deployed prior to said approaching object hitting the vehicle.

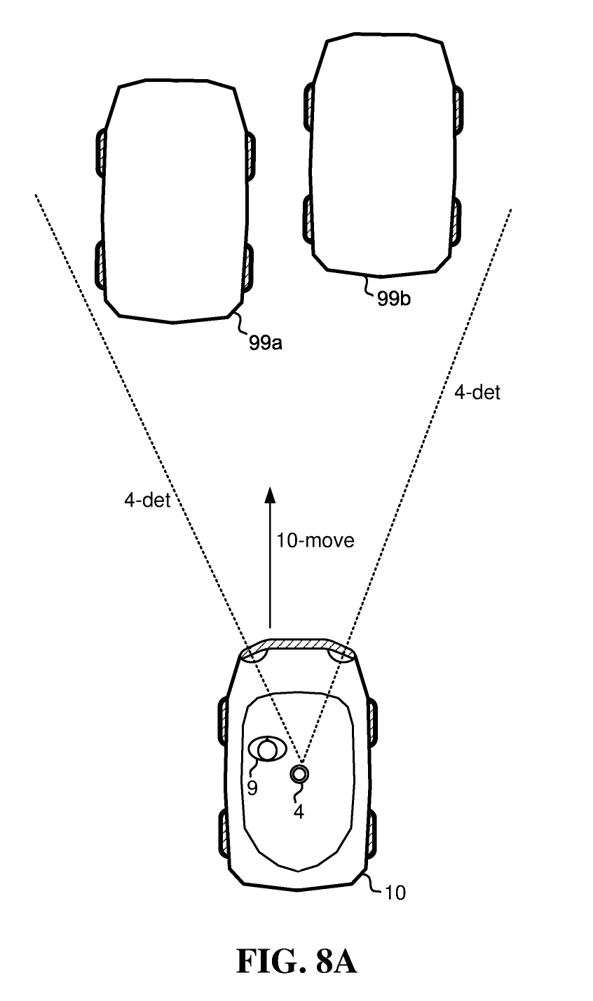

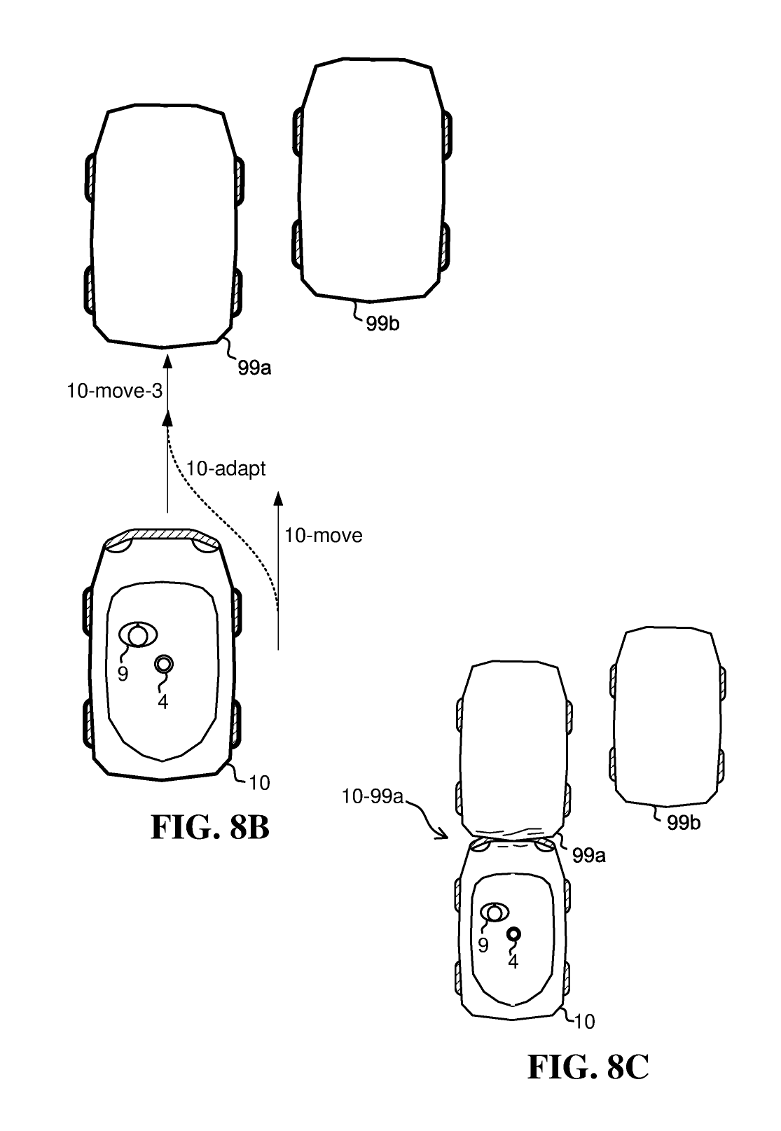

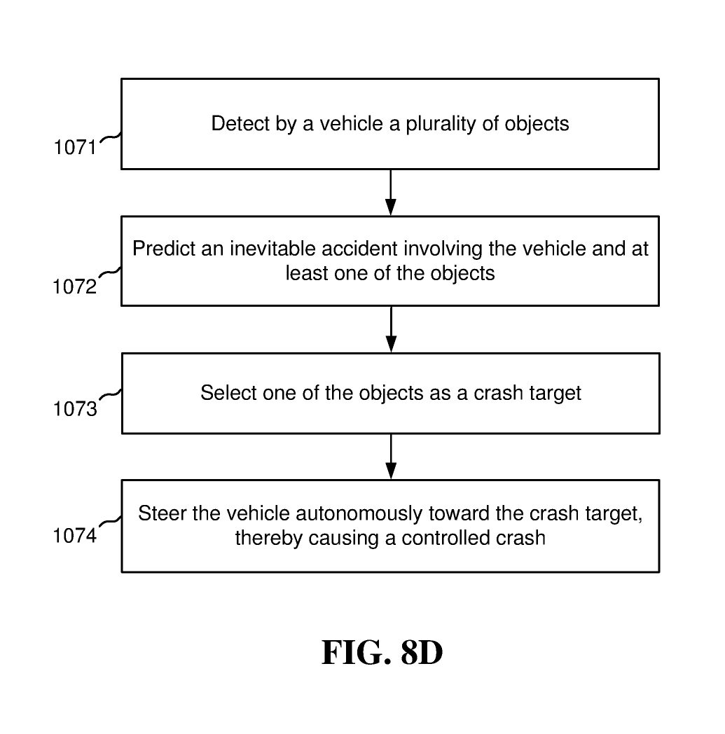

FIG. 8A illustrates one embodiment of an autonomous on-road vehicle 10 detecting 4-det a at least two immediate objects 99a, 99b. The autonomous on-road vehicle 10 includes a passenger 9 and a sensor 4 facilitating the detection 4-det, and is shown to be moving 10-move toward the two immediate objects 99a, 99b. The autonomous on-road vehicle 10 predicts that a collision is inevitable with either object 99a, or object 99b, or both. The autonomous on-road vehicle 10 therefore selects which of the objects 99a, 99b is the preferred object to collide with, in which said preference can be guided by different criteria. For example, the autonomous on-road vehicle 10 may select object 99a as the target for collision because object 99a travels faster than object 99b, and is therefore having a lower relative velocity to the autonomous on-road vehicle 10. In another example, object 99b is selected as the target for collision because object 99a includes children in the back seat, which are detected by sensor 4 and related data processing. In yet another example, object 99a is selected as the target for collision because object 99b is very massive, and will therefore inflict greater damage on autonomous on-road vehicle 10.

FIG. 8B illustrates one embodiment of the autonomous on-road vehicle 10 selecting a crash target (99a) out of the at least two immediate objects 99a, 99b. After selecting a crash target (e.g., object 99a), the autonomous on-road vehicle 10 adapts 10-adapt its path and/or orientation to facilitate a controlled collision with the object 99a selected. The adapted path 10-move-3 is operative to induce a collision with object 99a, while avoiding collision with object 99b. The autonomous on-road vehicle 10 is depicted as preparing for a frontal collision with object 99a, but it could also adapt orientation in order to facilitate a side-wise collision, or a rear-wise collision, or deploy a damage minimization mechanism in conjunction with the expected collision, all in accordance with some embodiments.

FIG. 8C illustrates one embodiment of the autonomous on-road vehicle 10 colliding intentionally 10-99a with the crash target selected 99a. The collision 10-99a is depicted as a frontal collision, but it could be any type of a planned/controlled collision, frontal or otherwise, with damage minimization mechanisms deployed or without, in accordance with some embodiments.

FIG. 8D illustrates one embodiment of a method for selecting a crash target in conjunction with an imminent car accident. The method includes: In step 1071, detecting 4-det, by a sensor 4 onboard a moving vehicle 10, a plurality of immediate objects (e.g., 99a, 99b, FIG. 8A). In step 1072, predicting, by the moving vehicle 10, based on said detection, that an accident is imminent in conjunction with the moving vehicle 10 and at least one of the immediate objects 99a, 99b. In step 1073, selecting, by the moving vehicle 10, out of the plurality of immediate objects 99a, 99b, one of the immediate objects (e.g., 99a) as a crash target predicted to cause minimal damage as a result of the imminent accident. In step 1074, autonomously steering 10-adapt (FIG. 8B) the moving vehicle 10 toward 10-move-3 the crash target (e.g., 99a), thereby causing a controlled accident 10-99a (FIG. 8C) in conjunction with the crash target 99a, and consequently avoiding an accident in conjunction with the other immediate objects (e.g., 99b).

In one embodiment, the plurality of immediate objects is at least two other cars 99a, 99b (FIG. 8A), in which said crash target is one of the two other cars (e.g., 99a) that is less likely to cause catastrophic damage as a result of the accident 10-99a (FIG. 8C).

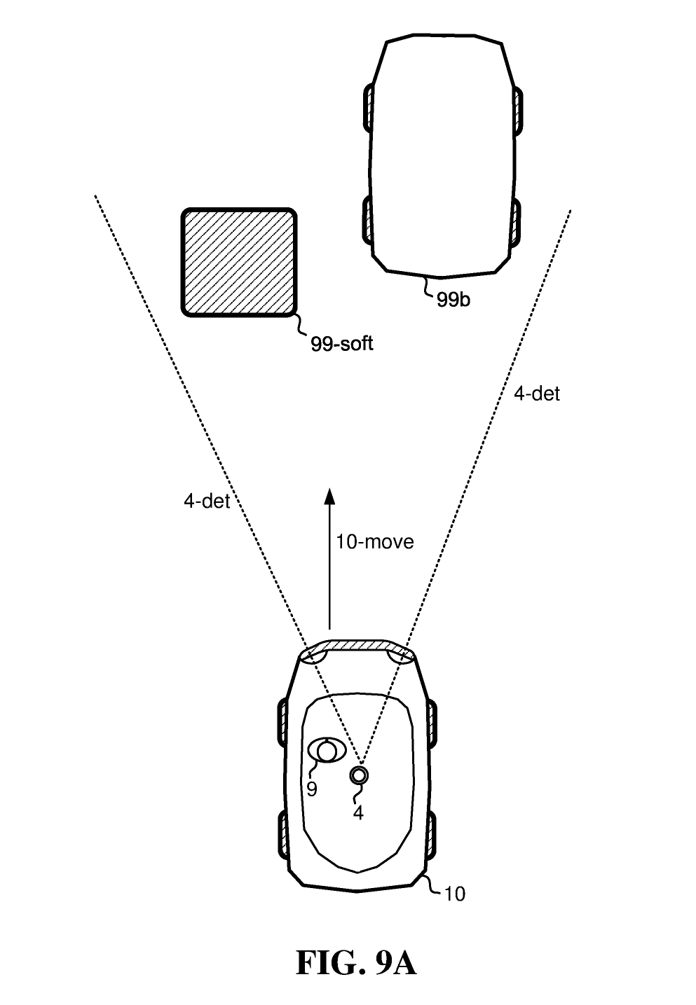

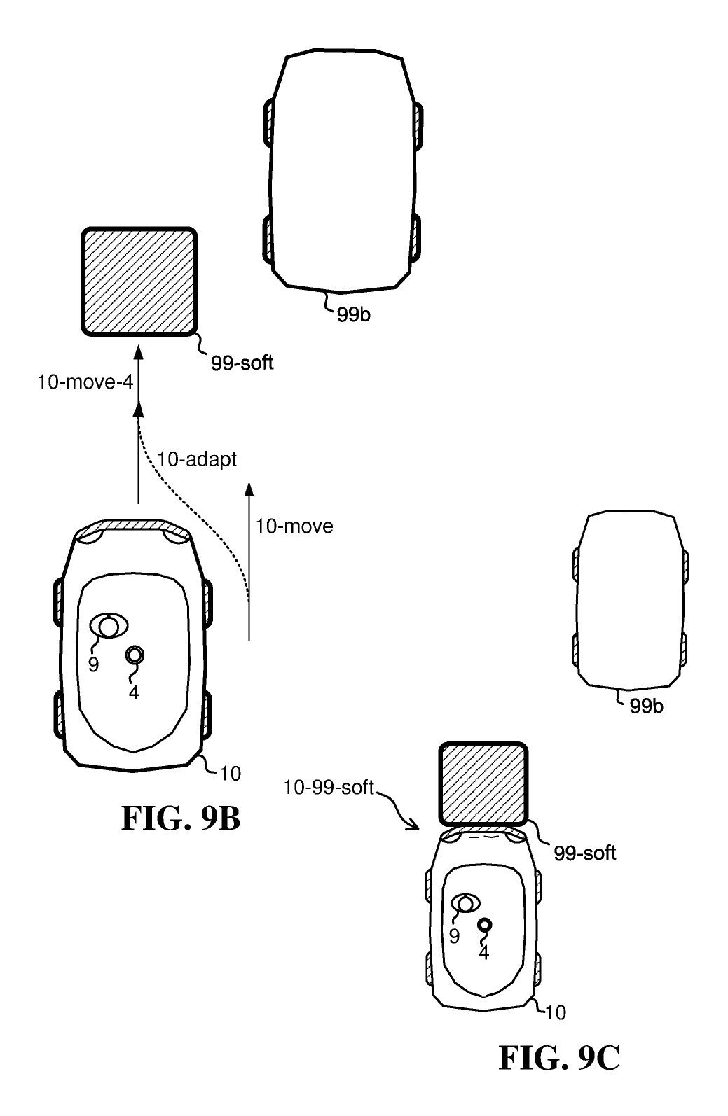

In one embodiment, the plurality of immediate objects is at least one specific object (e.g., 99b, FIG. 9A) and one stationary soft target 99-soft (FIG. 9A), in which said crash target is the stationary soft target 99-soft, thereby avoiding an accident in conjunction with the at least one specific object (e.g., 99b). In one embodiment, the stationary soft target 99-soft is one of a plurality of stationary soft targets spread along roads, in which the stationary soft targets are specifically designed to function as soft crash targets. In one embodiment, the at least one specific object is another vehicle 99b. In one embodiment, the at least one specific object is a pedestrian 19.

One embodiment is a system operative to select a crash target in conjunction with an imminent accident. The system includes a moving vehicle 10 and a sensor 4 onboard. The system is configured to autonomously steer the moving vehicle 10 toward a crash target, thereby causing a controlled accident in conjunction with the crash target, and consequently avoiding an accident in conjunction with other immediate objects.

FIG. 9A illustrates one embodiment of an autonomous on-road vehicle 10 detecting 4-det a at least two immediate objects 99b, 99-soft including one soft target 99-soft. The soft object 99-soft is any object, typically a stationary object fixed to the ground, that is designed to absorb, deflect, alleviate, or otherwise decrease an impact of a vehicle colliding therewith. The soft object 99-soft could be indeed soft, but it could also be elastic, or designed to collapse and absorb a collision impact, or even an active object that inflates to a cushion upon detection of an approaching vehicle. The soft object 99-soft could be a single object, or it could be a part of a series of objects deployed on road sides specifically to act as crash targets, or it could be a shock absorbing fence or a wall. The autonomous on-road vehicle 10 includes a passenger 9 and a sensor 4 facilitating the detection 4-det, and is shown to be moving 10-move toward the two immediate objects 99b, 99-soft. The autonomous on-road vehicle 10 predicts that a collision is inevitable with either object 99-soft, or object 99b, or both. The autonomous on-road vehicle 10 therefore selects the soft object 99-soft as the crash target, and thereby avoiding a collision with object 99b.

FIG. 9B illustrates one embodiment of the autonomous on-road vehicle 10 selecting the soft target 99-soft as a crash target. After selecting the crash target 99-soft, the autonomous on-road vehicle 10 adapts 10-adapt its path and/or orientation to facilitate a controlled collision with the crash target 99-soft. The adapted path 10-move-4 is operative to induce a collision with object 99-soft, while avoiding collision with object 99b. The autonomous on-road vehicle 10 is depicted as preparing for a frontal collision with object 99-soft, but it could also adapt orientation in order to facilitate a side-wise collision, or a rear-wise collision, or deploy a damage minimization mechanism in conjunction with the expected collision, all in accordance with some embodiments.

FIG. 9C illustrates one embodiment of the autonomous on-road vehicle 10 colliding 10-99-soft intentionally with the soft target 99-soft. The collision 10-99-soft is depicted as a frontal collision, but it could be any type of a planned/controlled collision, frontal or otherwise, with damage minimization mechanisms deployed or without, in accordance with some embodiments.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A method for reducing or avoiding injuries in conjunction with an imminent collision of an autonomous on-road vehicle with a foreign object, comprising:
detecting, using sensors onboard an autonomous on-road vehicle currently moving, a foreign object approaching the autonomous on-road vehicle;
predicting, by the autonomous on-road vehicle, based on said detection and related data processing, that said foreign object is about to collide with the autonomous on-road vehicle;
identifying positions of all passengers in the autonomous on-road vehicle; and
adapting autonomously a current trajectory or orientation of the autonomous on-road vehicle, based on said prediction and identification, so as to cause the autonomous on-road vehicle to collide with the foreign object in a particular spot or orientation of the autonomous on-road vehicle that is likely to reduced or avoid injury to the passengers.

2. The method of claim 1, wherein:
said identification comprises identifying a passenger seating on a left-hand side of the autonomous on-road vehicle and identifying that no passenger is seating on a right-hand side of the autonomous on-road vehicle; and
said adaptation comprises adapting the current orientation of the autonomous on-road vehicle so as to cause the right-hand side of the autonomous on-road vehicle to collide with the foreign object, in which the particular spot is a spot located at the right-hand side of the autonomous on-road vehicle.

3. The method of claim 2, wherein said collision occurs no more than 1 (one) seconds after said prediction, thereby preventing the autonomous on-road vehicle from avoiding the collision.

4. The method of claim 1, wherein:
said prediction comprises predicting that the foreign object is about to collide with a front side of the autonomous on-road vehicle;
said identification comprises identifying a passenger seating in a front seat of the autonomous on-road vehicle and identifying that no passenger is seating in a back seat of the autonomous on-road vehicle; and
said adaptation comprises adapting the current orientation of the autonomous on-road vehicle so as to rotate the autonomous on-road vehicle and cause a back side of the autonomous on-road vehicle to collide with the foreign object, in which the particular spot is a spot located at the back side of the autonomous on-road vehicle.

5. The method of claim 1, wherein:
said prediction comprises predicting that the foreign object is about to collide with a front-left side of the autonomous on-road vehicle;
said identification comprises identifying a passenger seating in a front-left seat of the autonomous on-road vehicle and identifying that no passenger is seating in a front-right seat of the autonomous on-road vehicle; and
said adaptation comprises adapting the current trajectory of the autonomous on-road vehicle so as to cause a front-right side of the autonomous on-road vehicle to collide with the foreign object.

6. The method of claim 1, wherein said collision occurs no more than 2 (two) seconds after said prediction, thereby preventing the autonomous on-road vehicle from avoiding the collision.

7. The method of claim 6, wherein said detection comprises detecting the foreign object suddenly entering into a lane on which the autonomous on-road vehicle currently moves.

8. The method of claim 6, wherein said detection comprises detecting the foreign object suddenly stopping in front of the autonomous on-road vehicle.

9. The method of 8, wherein said sudden stop is caused by the foreign object being involved in a car accident.

10. The method of claim 6, wherein said prediction comprises predicting that any attempt for a collision-avoiding maneuver by the autonomous on-road vehicle would have taken too long to actually avoid the collision.

11. The method of claim 6, wherein said prediction comprises predicting that any attempt for a collision-avoiding maneuver by the autonomous on-road vehicle would have caused catastrophic damage to either the autonomous on-road vehicle, the foreign object, or to another object in the vicinity.

12. The method of claim 1, wherein said prediction that said foreign object is about to collide with the autonomous on-road vehicle, is made by the autonomous on-road vehicle, as a result of the autonomous on-road vehicle concluding that the accident is inevitable and that any maneuver will not prevent the collision.

13. The method of claim 1, wherein said prediction that said foreign object is about to collide with the autonomous on-road vehicle, is made by the autonomous on-road vehicle, as a result of the autonomous on-road vehicle concluding that the accident is avoidable, and that a maneuver could prevent the collision, but such a maneuver would cause damage in conjunction with hitting another object.

14. A method for reducing or avoiding injuries in conjunction with an imminent collision of an autonomous on-road vehicle with a foreign object, comprising:
detecting, using sensors onboard an autonomous on-road vehicle currently moving, a foreign object approaching the autonomous on-road vehicle;
predicting, by the autonomous on-road vehicle, based on said detection and related data processing, that said foreign object is about to collide with the autonomous on-road vehicle; and
adapting autonomously a current trajectory or orientation of the autonomous on-road vehicle, based on said prediction and detection, so as to cause the autonomous on-road vehicle to collide with the foreign object in a particular spot of the autonomous on-road vehicle that is specifically designed to contain or at least reduce an impact of said collision.

15. The method of claim 14, wherein the particular spot comprises a spring-like mechanism operative to be deployed from a contracted position into an extracted position prior to the collision and as a result of said prediction.

16. The method of claim 14, wherein the particular spot comprises a front section of the autonomous on-road vehicle operative to collapse during said collision.

17. The method of claim 14, wherein said prediction that said foreign object is about to collide with the autonomous on-road vehicle, is made by the autonomous on-road vehicle, as a result of the autonomous on-road vehicle concluding that the accident is inevitable and that any maneuver will not prevent the collision.

18. The method of claim 14, wherein said prediction that said foreign object is about to collide with the autonomous on-road vehicle, is made by the autonomous on-road vehicle, as a result of the autonomous on-road vehicle concluding that the accident is avoidable, and that a maneuver could prevent the collision, but such a maneuver would cause damage in conjunction with hitting another object.

19. A method for reducing or avoiding injuries in conjunction with an imminent collision of an autonomous on-road vehicle with a pedestrian, comprising:
detecting, using sensors onboard an autonomous on-road vehicle currently moving, that the autonomous on-road vehicle is approaching a pedestrian;
predicting, by the autonomous on-road vehicle, based on said detection and related data processing, that said approach is being made too fast to avoid hitting the pedestrian; and
adapting autonomously a current trajectory or orientation of the autonomous on-road vehicle, based on said prediction and detection, so as to cause the autonomous on-road vehicle to collide with the pedestrian in a particular soft spot of the autonomous on-road vehicle that is specifically designed to contain or at least reduce an impact of said collision on the pedestrian.

20. The method of claim 19, wherein the particular soft spot comprises at least one of: (i) a cushion or another soft element, (ii) an inflatable cushion, which inflates upon said detection and prediction, (iii) a static cushion, (iv) a spring-like mechanism operative to be deployed from a contracted position into an extracted position prior to the collision and as a result of said prediction, and (v) a certain front section or element of the car operative to collapse during said collision.
